(19) United States
(12) Patent Application Publication
(10) Pub. No.: US 2026/0260495 A1
(43) Pub. Date: Sep. 3, 2026

(54) MANAGEMENT METHOD, MOBILE OBJECT, AND INFORMATION PROCESSING APPARATUS

(71) Applicant: Panasonic Intellectual Property Management Co., Ltd., Osaka (JP)

(72) Inventor: Yoshihiko KAMIYA, Osaka Fu (JP)

(73) Assignee: Panasonic Intellectual Property Management Co., Ltd., Osaka (JP)

(21) Appl. No.: 19/654,984

(22) Filed: Apr. 22, 2026

Related U.S. Application Data
(63) Continuation of application No. PCT/JP2024/039034, filed on Nov. 1, 2024.

(30) Foreign Application Priority Data
Nov. 2, 2023 (JP) 2023-188682

(51) Int. Cl. G06V 20/54; G06T 3/40

(52) U.S. Cl. CPC G06V 20/54; G06T 3/40

(57) ABSTRACT

A management method according to the present disclosure includes determining a communication amount between a management apparatus and a mobile object according to a task type of remote management of the mobile object. The management apparatus is capable of communicating with the mobile object. The management method includes transmitting, to the mobile object, a communication amount instruction. The communication amount instruction includes a request for performing communication with the determined communication amount.

### CROSS-REFERENCE TO RELATED APPLICATIONS

This application is a continuation of International Application No. PCT/JP2024/039034, filed on Nov. 1, 2024 which claims the benefit of priority of the prior Japanese Patent Application No. 2023-188682, filed on Nov. 2, 2023, the entire contents of which are incorporated herein by reference.

### FIELD

The present disclosure relates to a management method, a mobile object, and an information processing apparatus.

### BACKGROUND

A management apparatus connected to a mobile object via a communication link can perform remote management of the mobile object by communicating with the mobile object. It is desirable, in the remote management, that the communication amount between the management apparatus and the mobile object is appropriate.

Related techniques are described in WO 2020/090285 A, and WO 2019/208266 A.

There are cases where a mobile object is capable of performing communication with the outside via a communication link. When the mobile object has a capability to communicate with the outside via a communication link, the convenience of the mobile object is improved. For example, this enables construction of a management system for collecting and managing sensor information regarding surrounding environment of the mobile object in the management apparatus via a communication link, enabling the management system to perform remote management of the state of the mobile object.

On the other hand, when the communication amount used when the mobile object communicates with the management apparatus via the communication link for remote management is excessive, there might be occurrence of communication delays, having a possibility of making it difficult to perform efficient remote management.

The present disclosure provides a management method, a mobile object, and an information processing apparatus capable of optimizing the communication amount between the management apparatus and the mobile object.

### SUMMARY

A management method according to the present disclosure includes determining a communication amount between a management apparatus and a mobile object according to a task type of remote management of the mobile object. The management apparatus is capable of communicating with the mobile object. The management method includes transmitting, to the mobile object, a communication amount instruction. The communication amount instruction includes a request for performing communication with the determined communication amount.

### BRIEF DESCRIPTION OF THE DRAWINGS

FIG. 1 is a diagram illustrating a schematic configuration of a management system according to a first embodiment;

FIG. 2 is a diagram illustrating determination of resolution of an image corresponding to the quantity of monitoring targets corresponding to the first embodiment;

FIG. 3 is a diagram illustrating determination of resolution of an image corresponding to a screen layout in the first embodiment;

FIG. 4 is a sequence diagram illustrating a management method according to the first embodiment;

FIG. 5 is a sequence diagram illustrating a management method according to a modification of the first embodiment;

FIG. 6 is a diagram illustrating a schematic configuration of a management system according to a second embodiment;

FIG. 7 is a diagram illustrating a functional configuration of a mobile object in the second embodiment;

FIG. 8 is a diagram illustrating a hardware configuration of the mobile object according to the second embodiment;

FIG. 9 is a diagram illustrating a functional configuration of a server according to the second embodiment;

FIG. 10 is a diagram illustrating a hardware configuration of the server according to the second embodiment;

FIG. 11 is a diagram illustrating a functional configuration of a management terminal according to the second embodiment;

FIGS. 12A and 12B are diagrams illustrating a data structure of a correspondence table according to the second embodiment;

FIGS. 13A and 13B are diagrams illustrating a data structure of a correspondence table according to the second embodiment;

FIG. 14 is a diagram illustrating a hardware configuration of a management terminal according to the second embodiment;

FIG. 15 is a sequence diagram illustrating a management method according to the second embodiment;

FIG. 16 is a flowchart illustrating a communication amount determination process according to the second embodiment;

FIG. 17 is a sequence diagram illustrating a management method according to a first modification of the second embodiment;

FIG. 18 is a sequence diagram illustrating a management method according to a second modification of the second embodiment;

FIGS. 19A to 19C are diagrams illustrating an operation of a monitoring screen in the second modification of the second embodiment; and

FIG. 20 is a sequence diagram illustrating a management method according to a third modification of the second embodiment.

### DETAILED DESCRIPTION

Hereinafter, an embodiment of a management method according to the present disclosure will be described with reference to the drawings.

### First Embodiment

The management method according to a first embodiment is used for remote management of a mobile object in a management system in which a mobile object and a management apparatus are connected to each other via a communication link, and this method has enhanced features for optimizing the communication amount between the management apparatus and the mobile object.

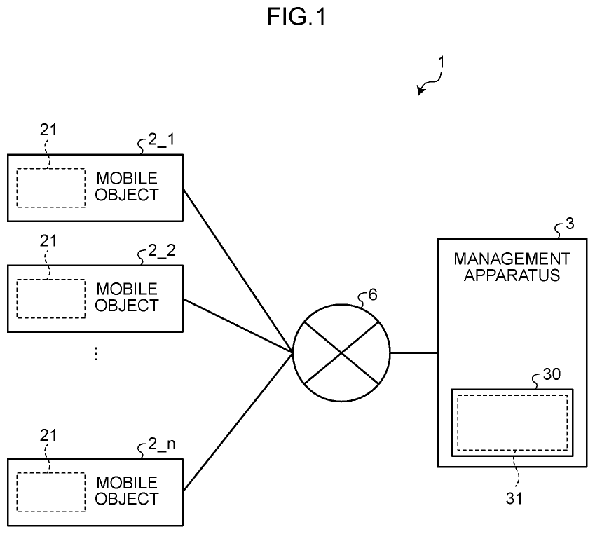

The management method according to the first embodiment may be executed by a management system 1 as illustrated in FIG. 1. FIG. 1 is a diagram illustrating a schematic configuration of the management system 1.

The management system 1 may be configured to be able to perform remote management of a plurality of mobile objects. The management system 1 includes a plurality of mobile objects 2_1 to 2_n, a communication link 6, and a management apparatus 3. n is an arbitrary integer of 2 or more. The plurality of mobile objects 2_1 to 2_n are communicably connected to the management apparatus 3 via a communication link 6.

The mobile object 2 each may be any vehicle having a communication function. The mobile object 2 may be capable of allowing boarding of a driver. The mobile object 2 may be able to autonomously travel in a state where the driver is on board, or may be able to perform unmanned autonomous travel. The mobile object 2 may be able to travel under the remote manipulation in a state where the driver is on board, or may be able to perform unmanned travel under the remote manipulation. The mobile object 2 is, for example, an automobile, a two-wheeled motorcycle, a three-wheeled motorcycle, a bicycle, a kick scooter, or a senior mobility scooter.

The communication link 6 may include a wireless communication link at least on the side of mobile object 2, and may further include a wired communication link between the wireless communication link and the management apparatus 3. The wireless communication link includes a communication link using a Radio Access Technology (RAT) such as Long Term Evolution (LTE), New Radio (NR), Wi-Fi, and Bluetooth (registered trademark). The wired communication link includes the Internet, a telephone switching network, etc.

In the management system 1, the management apparatus 3 may be managed by a manufacturer of the mobile object 2. The management apparatus 3 can perform remote management of the state of the mobile object 2. The management apparatus 3 performs state monitoring and operation control of the mobile object 2.

Each of the mobile objects 2 includes a sensor 21. The sensor 21 can sense the surrounding environment of the mobile object 2 and acquire a result of the sensing as sensor information. The mobile object 2 holds mobile object information related to its own attribute (for example, an ID, etc.). The sensor 21 may be an imaging sensor, for example, and may be capable of acquiring an image around the mobile object 2 as image information. The sensor 21 may be, for example, a remaining battery level sensor, and may be capable of acquiring the remaining battery level of the mobile object 2 as mobile object state information. The sensor 21 may be a temperature sensor, for example, and may be capable of acquiring the temperature of the mobile object 2 as the mobile object state information. The sensor 21 may be a speed sensor, for example, and may be capable of acquiring the speed of the mobile object 2 as the mobile object state information. The sensor 21 may be an acceleration sensor, for example, and may be capable of acquiring the acceleration of the mobile object 2 as the mobile object state information. The sensor 21 may be a distance measuring sensor, for example, and may be capable of acquiring a distance to an object around the mobile object 2 as the environment sensor information. The sensor 21 may be a position sensor, for example, and may be capable of receiving a Global Positioning System (GPS) signal from a GPS satellite and acquiring a position of the mobile object 2 based on the GPS signal, as position information. When having acquired the sensor information, the mobile object 2 generates transmission information including the sensor information and the mobile object information, and transmits the generated transmission information to the management apparatus 3 via the communication link 6. The sensor information includes image information, mobile object state information, environment sensor information, and position information.

The management apparatus 3 includes a display 30, and can execute various tasks regarding remote management of the mobile object 2 via a monitoring screen 31 on the display 30. The monitoring screen 31 is a display region on the display 30. The task that is executable by the management apparatus 3 includes a task related to state monitoring of the mobile object 2 and a task related to operation control of the mobile object 2. The task type that is executable by the management apparatus 3 may include at least one of “monitoring with image”, “monitoring without image”, “attention”, and “manipulation”. Among these, “monitoring with image”, “monitoring without image”, and “attention” are tasks related to state monitoring of the mobile object 2, while “manipulation” is a task related to operation control of the mobile object 2.

The state of the mobile object 2 to be monitored includes the position of the mobile object 2, the attitude of the mobile object 2, the stress applied to the mobile object 2 from the road surface, the traveling state of the mobile object 2, the traveling speed of the mobile object 2, the traveling direction of the mobile object 2, the presence or absence of an object around the mobile object 2, the distance to the object around the mobile object 2, the direction of the object around the mobile object 2, the possibility of collision of the mobile object 2, the communication situation of the mobile object 2, weather information around the position of the mobile object 2, etc.

“Monitoring with image” includes monitoring the state of the mobile object 2 using an image acquired by the sensor 21 (for example, an imaging sensor) of the mobile object 2.

The “monitoring without image” includes monitoring the state of the mobile object 2 using non-image information acquired by the sensor 21 (for example, distance measuring sensor) of the mobile object 2. Alternatively, “monitoring without image” includes monitoring the state of the mobile object 2 in an emergency using information obtained by abstracting the state of the mobile object 2 and the situation around the mobile object 2.

The “attention” includes paying attention to one of a plurality of mobile objects 2_1 to 2_n and monitoring the state of the mobile object 2 using an image acquired by a sensor 21 (for example, an imaging sensor) of the mobile object 2. Alternatively, in a case where one mobile object 2 includes a plurality of sensors 21, “attention” includes paying attention to one sensor 21 among the plurality of sensors 21 and monitoring the state of the mobile object 2 using an image acquired by the sensor 21 (for example, an imaging sensor).

The operation of the mobile object 2 to be controlled includes activation of the mobile object 2, shutdown of the mobile object 2, stop of the mobile object 2, parking of the mobile object 2, start of traveling of the mobile object 2, turning of the mobile object 2, deceleration of the mobile object 2, acceleration of the mobile object 2, backward movement of the mobile object 2, warning display output of the mobile object 2, warning sound output of the mobile object 2, etc.

“Manipulation” includes controlling the operation of the mobile object 2 using an image acquired by the sensor 21 (for example, the imaging sensor) of the mobile object 2.

For example, the management apparatus 3 may determine the communication amount between the management apparatus 3 and the mobile object 2 according to the task type of remote management of the mobile object 2. The communication amount includes a communication amount of information transmitted from the mobile object 2 to the management apparatus 3 and a communication amount of information transmitted from the management apparatus 3 to the mobile object 2.

The management apparatus 3 may determine the resolution of the image data transmitted from the mobile object 2 to the management apparatus 3 according to the task type of management of the mobile object 2.

This makes it possible to suppress the communication amount of information transmitted from the mobile object 2 to the management apparatus 3 via the communication link 6 to an appropriate communication amount corresponding to the task type of management of the mobile object 2, and reduce the traffic of the communication link 6 between the management apparatus 3 and the mobile object 2 That is, it is possible to optimize the communication amount between the management apparatus 3 and the mobile object 2, and it is possible to suppress the communication delay between the management apparatus 3 and the mobile object 2.

The management apparatus 3 may predetermine the display size of the image on the monitoring screen 31 for each task type of management of the mobile object 2. The management apparatus 3 may predetermine the display sizes of the images to be displayed on the monitoring screen 31 when performing “monitoring with image”, “monitoring without image”, “attention”, and “manipulation” as W1×H1, W2×H2, W3×H3, and W4×H4, respectively. W1, W2, W3, and W4 each indicate the quantity of horizontal pixels in the screen. H1, H2, H3, and H4 each indicate the quantity of vertical pixels in the screen. The magnitude relationship between these display sizes may satisfy the following Mathematical Formulas 1 and 2.

$$W 2 = \text{?} < W 1 = W 4 < W 3 \qquad Mathematical Formula 1$$

$$H 2 = \text{?} < H 1 = H 4 < H 3 \qquad Mathematical Formula 2$$

The data size of the image data transmitted from the mobile object 2 to the management apparatus 3 may be determined in correspondence with the display size of the image displayed on the monitoring screen 31. For example, when the resolutions of the image data transmitted from the mobile object 2 to the management apparatus 3 are W1×H1, W2×H2, W3×H3, and W4×H4, the display sizes of the images displayed on the monitoring screen 31 can be W1×H1, W2×H2, W3×H3, and W4×H4, correspondingly. Alternatively, when the image data transmitted from the mobile object 2 to the management apparatus 3 is each image clipped in sizes of W1×H1, W2×H2, W3×H3, and W4×H4 from the original image acquired by the sensor 21, the display size of each image displayed on the monitoring screen 31 can also be W1×H1, W2×H2, W3×H3, and W4×H4, correspondingly.

When the task type of the management of the mobile object 2 is “monitoring with image”, the management apparatus 3 determines the display size of the image on the monitoring screen 31 to be W1×H1. The management apparatus 3 determines the resolution of the image data transmitted from the mobile object 2 to the management apparatus 3 as W1×H1 according to the display size W1×H1. The management apparatus 3 transmits, to the mobile object 2, a communication amount instruction including a request for setting the resolution of the image data to W1×H1. The management apparatus 3 waits without monitoring the mobile object 2 until receiving appropriate transmission information corresponding to the communication amount instruction. In a case where the sensor 21 is an imaging sensor, the mobile object 2 captures an image of the surrounding environment with the resolution W1×H1 by the sensor 21 according to the communication amount instruction, and transmits transmission information including the captured image to the management apparatus 3 via the communication link 6. Alternatively, according to the communication amount instruction, the mobile object 2 captures an image of the surrounding environment by the sensor 21, clips a partial image with the size of W1×H1 from the acquired image, and transmits transmission information including the clipped partial image to the management apparatus 3 via the communication link 6. This makes it possible for the management apparatus 3 to receive the transmission information, display an image of the display size W1×H1 corresponding to the transmission information on the monitoring screen 31, and monitor the mobile object 2. That is, according to the fact that the task type of the remote management is “monitoring with image”, the communication amount of the transmission information can be suppressed to the communication amount corresponding to the resolution W1×H1 or the size W1×H1, making it possible to appropriately perform monitoring of the mobile object 2.

When the task type of the management of the mobile object 2 is “attention”, the management apparatus 3 determines the display size of the image on the monitoring screen 31 to be W3×H3. The management apparatus 3 determines the resolution of the image data transmitted from the mobile object 2 to the management apparatus 3 as W3×H3 according to the display size W3×H3. The management apparatus 3 transmits, to the mobile object 2, a communication amount instruction including a request for setting the resolution of the image data to W3×H3. In a case where the sensor 21 is an imaging sensor, the mobile object 2 captures an image of the surrounding environment with the resolution W3×H3 by the sensor 21 according to the communication amount instruction, and transmits transmission information including the captured image to the management apparatus 3 via the communication link 6. Alternatively, according to the communication amount instruction, the mobile object 2 captures an image of the surrounding environment by the sensor 21, clips a partial image with the size of W3×H3 from the acquired image, and transmits transmission information including the partial image to the management apparatus 3 via the communication link 6. This makes it possible for the management apparatus 3 to receive the transmission information, display an image of the display size W3×H3 corresponding to the transmission information on the monitoring screen 31, and monitor the mobile object 2. That is, according to the fact that the task type of the remote management is “attention”, the communication amount of the transmission information can be suppressed to the communication amount corresponding to the resolution W3×H3 or the size W3×H3, making it possible to appropriately perform monitoring of the mobile object 2.

When the task type of the management of the mobile object 2 is “manipulation”, the management apparatus 3 determines the display size of the image on the monitoring screen 31 to be W4×H4. The management apparatus 3 determines the resolution of the image data transmitted from the mobile object 2 to the management apparatus 3 as W4×H4 according to the display size W4×H4. The management apparatus 3 transmits, to the mobile object 2, a communication amount instruction including a request for setting the resolution of the image data to W4×H4. In a case where the sensor 21 is an imaging sensor, the mobile object 2 captures an image of the surrounding environment with the resolution W4×H4 by the sensor 21 according to the communication amount instruction, and transmits transmission information including the captured image to the management apparatus 3 via the communication link 6. Alternatively, according to the communication amount instruction, the mobile object 2 captures an image of the surrounding environment by the sensor 21, clips a partial image with the size of W4×H4 from the acquired image, and transmits transmission information including the partial image to the management apparatus 3 via the communication link 6. This makes it possible for the management apparatus 3 to receive the transmission information, display an image of the display size W4×H4 corresponding to the transmission information on the monitoring screen 31, and monitor the mobile object 2. That is, according to the fact that the task type of the remote management is “manipulation”, the communication amount of the transmission information can be suppressed to the communication amount corresponding to the resolution W4×H4 or the size W4×H4, making it possible to appropriately perform monitoring of the mobile object 2.

Alternatively, the management apparatus 3 may determine the quantity of the mobile objects 2 to be monitoring targets in the management apparatus 3 according to the task type of management of the mobile object 2, and determine the resolution of the image data to be transmitted from the mobile object 2 to the management apparatus 3 according to the determined quantity of monitoring targets. The management apparatus 3 may determine the quantity of monitoring targets for the management apparatus and the travel specification of the mobile object 2 from the service content, and determine the resolution of the image data transmitted from the mobile object 2 to the management apparatus 3 according to the determined quantity of monitoring targets and the travel specification.

This makes it possible to suppress the communication amount of information transmitted from the mobile object 2 to the management apparatus 3 via the communication link 6 to an appropriate communication amount corresponding to the quantity of mobile objects 2 to be the monitoring targets, and reduce the traffic of the communication link 6 between the management apparatus 3 and the mobile object 2 That is, it is possible to optimize the communication amount between the management apparatus 3 and the mobile object 2, and it is possible to suppress the communication delay between the management apparatus 3 and the mobile object 2.

The management apparatus 3 may predetermine the display size of the image on the monitoring screen 31 for each quantity of monitoring targets. The resolution of the image data transmitted from the mobile object 2 to the management apparatus 3 may be determined in correspondence with the display size of the image displayed on the monitoring screen 31.

When the task type of the management of the mobile object 2 is “monitoring with image”, the management apparatus 3 determines the quantity of mobile objects 2 to be the monitoring targets as k. k is an integer of 2 or more and n or less. The management apparatus 3 determines the display size of the image on the monitoring screen 31 to be W11×H11 according to the fact that the quantity of monitoring targets is k. The management apparatus 3 determines the resolution of the image data transmitted from the mobile object 2 to the management apparatus 3 as W11×H11 according to the display size W11×H11.

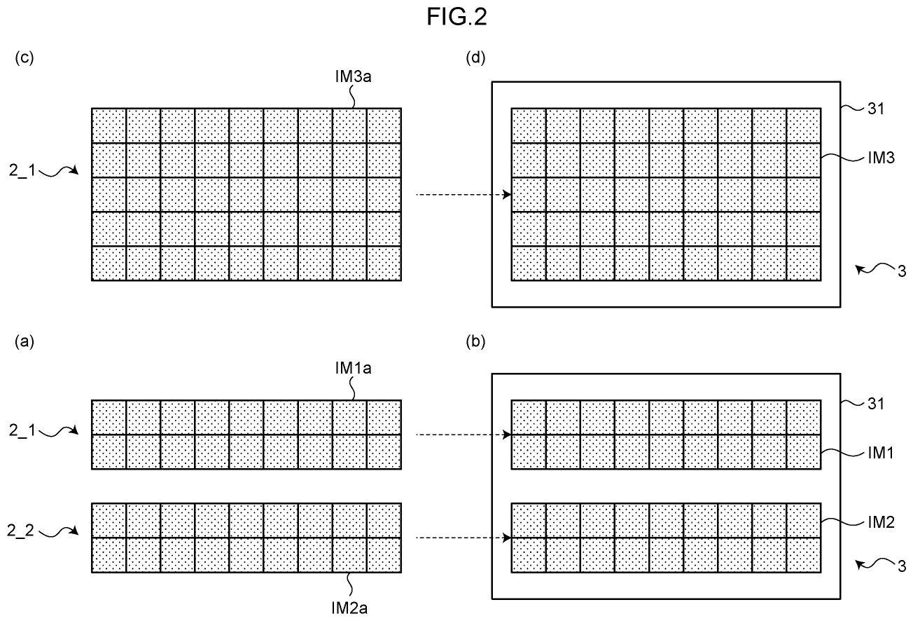

For example, when the task type of the management of the mobile object 2 is “monitoring with image”, the management apparatus 3 may determine the quantity of monitoring targets to be two, namely, the mobile object 2_1 and the mobile object 2_2 as illustrated at (a) in FIG. 2. FIG. 2 is a diagram illustrating determination of resolution of an image corresponding to the quantity of monitoring targets. According to the fact that the quantity of monitoring targets is two, the management apparatus 3 determines the display size of the images IM1 and IM2 of each of the mobile objects 2_1 and 2_2 to be 9 pixels×2 pixels as illustrated at (b) in FIG. 2. According to the display size of 9 pixels×2 pixels, the management apparatus 3 determines the resolution of the image data IM1a and IM2a transmitted from the mobile object 2 to the management apparatus 3 to be 9 pixels×2 pixels. FIG. 2 is a diagram illustrating adjustment of resolution of an image corresponding to the quantity of monitoring targets.

The management apparatus 3 illustrated in FIG. 1 transmits, to the mobile object 2, a communication amount instruction including a request for setting the resolution of the image data to W11×H11. In a case where the sensor 21 is an imaging sensor, the mobile object 2 captures an image of the surrounding environment by the sensor 21 according to the communication amount instruction to acquire an image with the resolution W11×H11, and transmits transmission information including the image to the management apparatus 3 via the communication link 6. This makes it possible for the management apparatus 3 to receive the transmission information, display an image of the display size W11×H11 corresponding to the transmission information on the monitoring screen 31, and monitor the mobile object 2.

In the case of (a) and b) in FIG. 2, according to the communication amount instruction, each of the mobile objects 2_1 and 2_2 captures an image of the surrounding environment with the sensor 21 to acquire an image with a resolution of 9 pixels×2 pixels, and transmits transmission information including the image to the management apparatus 3 via the communication link 6. This makes it possible for the management apparatus 3 to receive the transmission information, display the images IM1 and IM2 having a display size of 9 pixels×2 pixels corresponding to the transmission information on the monitoring screen 31, enabling monitoring of the mobile objects 2_1 and 2_2.

That is, according to the fact that the task type of the remote management is “monitoring with image”, the communication amount of the transmission information can be suppressed to the communication amount corresponding to the resolution W11×H11, making it possible to appropriately perform monitoring of the mobile object 2.

When the task type of the management of the mobile object 2 is “attention”, the management apparatus 3 determines the quantity of mobile objects 2 to be the monitoring targets as 1. The management apparatus 3 determines the display size of the image on the monitoring screen 31 to be W13×H13 according to the fact that the quantity of monitoring targets is 1. The management apparatus 3 determines the resolution of the image data transmitted from the mobile object 2 to the management apparatus 3 as W13×H13 according to the display size W13×H13.

For example, when the task type of management of the mobile object 2 is “attention”, the management apparatus 3 determines that the mobile object 2_1 should be “attention” as illustrated at (c) in FIG. 2, and determines the quantity of monitoring targets as 1, namely, the mobile object 2_1. The management apparatus 3 determines the display size of the image IM3 of the mobile object 2_1 to be 9 pixels×5 pixels as illustrated at (d) in FIG. 2 according to the fact that the quantity of monitoring targets is 1. The management apparatus 3 determines the resolution of the image data IM3a transmitted from the mobile object 2_1 to the management apparatus 3 to be 9 pixels×5 pixels according to the display size of 9 pixels×5 pixels.

The management apparatus 3 illustrated in FIG. 1 transmits, to the mobile object 2, a communication amount instruction including a request for setting the resolution of the image data to W13×H13. In a case where the sensor 21 is an imaging sensor, the mobile object 2 captures an image of the surrounding environment by the sensor 21 according to the communication amount instruction to acquire an image with the resolution W13×H13, and transmits transmission information including the image to the management apparatus 3 via the communication link 6. This makes it possible for the management apparatus 3 to receive the transmission information, display an image of the display size W13×H13 corresponding to the transmission information on the monitoring screen 31, and monitor the mobile object 2.

In the case of (c) and (d) of FIG. 2, according to the communication amount instruction, the mobile object 2_1 captures an image of the surrounding environment with the sensor 21 to acquire an image with a resolution of 9 pixels×5 pixels, and transmits transmission information including the image to the management apparatus 3 via the communication link 6. This makes it possible for the management apparatus 3 to receive the transmission information, display the image IM3 having a display size of 9 pixels×5 pixels corresponding to the transmission information on the monitoring screen 31, and monitor the mobile object 2_1.

That is, according to the fact that the task type of the remote management is “attention”, the communication amount of the transmission information can be suppressed to the communication amount corresponding to the resolution W13×H13, making it possible to appropriately perform monitoring of the mobile object 2.

Alternatively, the management apparatus 3 may determine the layout of the monitoring screen 31 of the management apparatus 3 according to the task type of management of the mobile object 2, and may determine the resolution of the image data transmitted from the mobile object 2 to the management apparatus 3 according to the determined layout of the monitoring screen 31.

This makes it possible to suppress the communication amount of information transmitted from the mobile object 2 to the management apparatus 3 via the communication link 6 to an appropriate communication amount corresponding to the layout of the monitoring screen 31, and reduce the traffic of the communication link 6 between the management apparatus 3 and the mobile object 2. That is, it is possible to optimize the communication amount between the management apparatus 3 and the mobile object 2, and it is possible to suppress the communication delay between the management apparatus 3 and the mobile object 2.

The management apparatus 3 may predetermine the display size of the image on the monitoring screen 31 for each layout of the monitoring screen 31. The resolution of the image data transmitted from the mobile object 2 to the management apparatus 3 may be determined in correspondence with the layout of the image displayed on the monitoring screen 31.

In a case where the mobile object 2 has m sensors 21 and the task type of management of the mobile object 2 is “monitoring with image”, the management apparatus 3 determines a layout in which m images are arranged as the layout of the monitoring screen 31 according to the fact that m images can be acquired by the mobile object 2. m is an integer of 2 or more. The management apparatus 3 may determine the display size of each of the m images equally to be W21×H21. The management apparatus 3 determines the resolution of the image data transmitted from the mobile object 2 to the management apparatus 3 as W21×H21 according to the display size W21×H21.

The management apparatus 3 illustrated in FIG. 1 transmits, to the mobile object 2, a communication amount instruction including a request for setting the resolution of each of the m pieces of image data to W21×H21. In a case where the sensor 21 is an imaging sensor, the mobile object 2 captures an image of the surrounding environment by the sensor 21 according to the communication amount instruction to acquire an image with the resolution W21×H21, and transmits transmission information including the image to the management apparatus 3 via the communication link 6. This makes it possible for the management apparatus 3 to receive the transmission information, display m images each having the display size W21×H21 corresponding to the transmission information side by side on the monitoring screen 31, and monitor the mobile object 2.

Alternatively, when determining the layout in which the m images are arranged, the management apparatus 3 may determine the display size of a main image among the m images to be relatively large W22×H22 and the display size of a sub image to be relatively small W23×H23. The management apparatus 3 determines, regarding the main image, the resolution of the image data transmitted from the mobile object 2 to the management apparatus 3 as W22×H22 according to the display size W22×H22. The management apparatus 3 determines, regarding the sub image, the resolution of the image data transmitted from the mobile object 2 to the management apparatus 3 as W23×H23 according to the display size W23×H23.

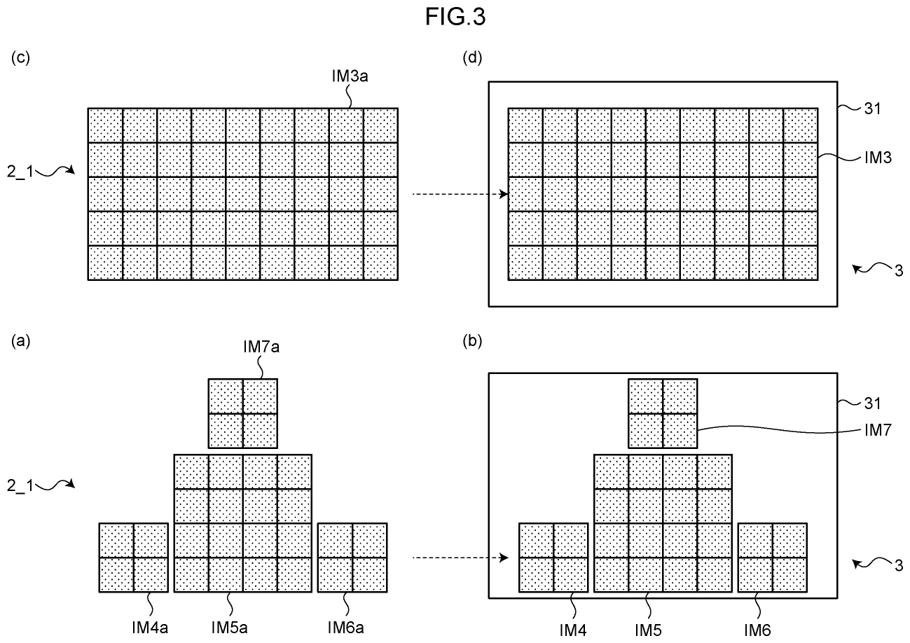

For example, in a case where the mobile object 2_1 has four sensors 21 and the task type of management of the mobile object 2 is “monitoring with image”, the management apparatus 3 can acquire four images IM4a to IM7a by the mobile object 2 as illustrated at (a) in FIG. 3. According to this, the management apparatus 3 may determine a layout in which four images IM4 to IM7 are arranged as illustrated at (b) in FIG. 3 as the layout of the monitoring screen 31. FIG. 3 is a diagram illustrating determination of resolution of an image corresponding to a screen layout. The management apparatus 3 may determine the display size of a main image IM5 among the four images IM4 to IM7 to be a relatively large 4 pixels×4 pixels, and may determine the display size of the sub images IM4, IM6, and IM7 to be a relatively small 2 pixels×2 pixels. The main image IM5 may be an image in front of the mobile object 2_1, and the sub images IM4, IM6, and IM7 may be images of the left side, the right side, and the rear side of the mobile object 2_1, respectively. Accordingly, on the monitoring screen 31, the sub images IM4 and IM6 may be arranged on the left and right of the main image IM5, and the sub image IM7 may be arranged above or below the main image IM5. Regarding the main image IM5, the management apparatus 3 determines the resolution of the image data transmitted from the mobile object 2_1 to the management apparatus 3 as 4 pixels×4 pixels according to the display size of 4 pixels×4 pixels. Regarding the sub images IM4, IM6, and IM7, the management apparatus 3 determines the resolution of the image data transmitted from the mobile object 2_1 to the management apparatus 3 as 2 pixels×2 pixels according to the display size of 2 pixels×2 pixels.

The management apparatus 3 illustrated in FIG. 1 transmits, to the mobile object 2, a communication amount instruction including a request for setting the resolution of the main image data to W22×H22 and the resolution of the sub image data to W23×H23. According to the communication amount instruction, the mobile object 2 captures an image of the surrounding environment with the sensor 21 being a main sensor to acquire an image with the resolution W22×H22, captures an image of the surrounding environment with the sensor 21 being a sub sensor to acquire an image with the resolution W23×H23, and transmits transmission information including the main image and the sub images to the management apparatus 3 via the communication link 6. This makes it possible for the management apparatus 3 to receive the transmission information, display the main image having the display size W22×H22 corresponding to the transmission information and the sub images each having the display size W23×H23 side by side on the monitoring screen 31, and monitor the mobile object 2.

In the case of (a) and (b) in FIG. 3, according to the communication amount instruction, the mobile object 2_1 captures an image of the surrounding environment with the sensor 21 being the main sensor to acquire an image IM5a having a resolution of 4 pixels×4 pixels, captures an image of the surrounding environment with the sensor 21 being the sub sensor to acquire images IM4a, IM6a, and IM7a having the resolution of 2 pixels×2 pixels, and transmits transmission information including the main image IM5a and the sub images IM4a, IM6a, and IM7a to the management apparatus 3 via the communication link 6. This makes it possible for the management apparatus 3 to receive the transmission information, display the image IM5 having a display size of 4 pixels×4 pixels and the images IM4, IM6, and IM7 each having the display size of 2 pixels×2 pixels corresponding to the transmission information side by side on the monitoring screen 31, and monitor the mobile object 2_1.

That is, according to the fact that the task type of remote management is “monitoring with image”, the communication amount of the transmission information can be suppressed to the communication amount corresponding to the resolution W22×H22 or W23×H23, making it possible to appropriately monitor the mobile object 2.

In a case where the mobile object 2 has m sensors 21 and the task type of management of the mobile object 2 is “attention”, the management apparatus 3 determines a layout in which one image is arranged as the layout of the monitoring screen 31 according to the fact that an image of one sensor 21 among the m sensors 21 is a target of attention. The management apparatus 3 determines the display size of the one image as W24×H24. The management apparatus 3 determines the resolution of the image data transmitted from the mobile object 2 to the management apparatus 3 as W24×H24 according to the display size W24×H24.

For example, in a case where the mobile object 2_1 has four sensors 21 and the task type of management of the mobile object 2 is “attention”, the management apparatus 3 determines a layout in which one image IM3 is arranged as the layout of the monitoring screen 31 as illustrated at (d) in FIG. 3 according to the fact that the image IM3a of one sensor 21 is a target of attention as illustrated at (c) in FIG. 3. The management apparatus 3 determines the display size of the one image to be 9 pixels×5 pixels. The management apparatus 3 determines the resolution of the image data transmitted from the mobile object 2 to the management apparatus 3 to be 9 pixels×5 pixels according to the display size of 9 pixels×5 pixels.

The management apparatus 3 illustrated in FIG. 1 transmits, to the mobile object 2, a communication amount instruction including a request for setting the resolution of the image data to W24×H24. In a case where the sensor 21 is an imaging sensor, the mobile object 2 captures an image of the surrounding environment by the sensor 21 according to the communication amount instruction to acquire an image with the resolution W24×H24, and transmits transmission information including the image to the management apparatus 3 via the communication link 6. This makes it possible for the management apparatus 3 to receive the transmission information, display an image of the display size W24×H24 corresponding to the transmission information on the monitoring screen 31, and monitor the mobile object 2.

In the case of (c) and (d) in FIG. 3, according to the communication amount instruction, the mobile object 2_1 captures an image of the surrounding environment with the sensor 21 to acquire an image with a resolution of 9 pixels×5 pixels, and transmits transmission information including the image to the management apparatus 3 via the communication link 6. This makes it possible for the management apparatus 3 to receive the transmission information, display the image having a display size of 9 pixels×5 pixels corresponding to the transmission information on the monitoring screen 31, and monitor the mobile object 2_1.

That is, according to the fact that the task type of the remote management is “attention”, the communication amount of the transmission information can be suppressed to the communication amount corresponding to the resolution W24×H24, making it possible to appropriately perform monitoring of the mobile object 2.

Alternatively, the management apparatus 3 may determine the communication amount from the management apparatus 3 to the mobile object 2 according to the task type of the remote management of the mobile object 2. The management apparatus 3 may determine the transfer rate of a synchronization signal transmitted from the management apparatus 3 to the mobile object 2 according to the task type of management of the mobile object 2.

This makes it possible to suppress the communication amount of information transmitted from the management apparatus 3 to the mobile object 2 via the communication link 6 to an appropriate communication amount corresponding to the task type of management of the mobile object 2, and reduce the traffic of the communication link 6 between the management apparatus 3 and the mobile object 2 That is, it is possible to optimize the communication amount between the management apparatus 3 and the mobile object 2, and it is possible to suppress the communication delay between the management apparatus 3 and the mobile object 2.

The management apparatus 3 may predetermine the transfer rate of the synchronization signal for each task type of management of the mobile object 2. The management apparatus 3 may predetermine transfer rates of synchronization signals to be transmitted to the mobile object 2 at the time of performing “monitoring with image”,“ monitoring without image”, “attention”, and “manipulation” as B1, B2, B3, and B4, respectively. The magnitude relationship of these transfer rates may satisfy the following Mathematical Formula 3.

$$B 1 < B 2 = B 4 < B 3 \qquad Mathematical Formula 3$$

The use band of the synchronization signal at the time of transmission in the communication link 6 can be determined in correspondence with the transfer rate of the synchronization signal. When the transfer rates of the synchronization signals are B1, B2, B3, and B4, the use bands of the synchronization signals at the time of transmission in the communication link 6 can also be B1, B2, B3, and B4, respectively.

When the task type of the management of the mobile object 2 is “monitoring with image”, the management apparatus 3 determines the transfer rate of the synchronization signal as B1. The management apparatus 3 generates a synchronization signal according to the transfer rate B1 of the synchronization signal and transmits the generated synchronization signal to the mobile object 2 at the transfer rate B1. In a case where the sensor 21 is an imaging sensor, the mobile object 2 captures an image of the surrounding environment by the sensor 21 at a timing corresponding to the synchronization signal, acquires the image, and transmits transmission information including the image to the management apparatus 3 via the communication link 6. This makes it possible for the management apparatus 3 to receive the transmission information, display an image corresponding to the transmission information on the monitoring screen 31, and monitor the mobile object 2. That is, according to the fact that the task type of the remote management is “monitoring with image”, the communication amount of the transmission information can be suppressed to the communication amount according to the transfer rate B1 of the synchronization signal, making it possible to appropriately monitor the mobile object 2.

When the task type of the management of the mobile object 2 is “monitoring without image”, the management apparatus 3 determines the transfer rate of the synchronization signal as B2. The management apparatus 3 generates a synchronization signal according to the transfer rate B2 of the synchronization signal and transmits the generated synchronization signal to the mobile object 2 at the transfer rate B2. Since the “monitoring without image” is monitoring based on non-image information (for example, distance measurement information), it is easy to increase the temporal resolution. In consideration of this point, the transfer rate B2 can be set to be higher than the transfer rate B1. In a case where the sensor 21 is an imaging sensor, the mobile object 2 captures an image of the surrounding environment by the sensor 21 at a timing corresponding to the synchronization signal, acquires the image, and transmits transmission information including the image to the management apparatus 3 via the communication link 6. This makes it possible for the management apparatus 3 to receive the transmission information, display an image corresponding to the transmission information on the monitoring screen 31, and monitor the mobile object 2. That is, according to the fact that the task type of the remote management is “monitoring without image”, the communication amount of the transmission information can be suppressed to the communication amount according to the transfer rate B2 of the synchronization signal, making it possible to appropriately monitor the mobile object 2.

When the task type of the management of the mobile object 2 is “attention”, the management apparatus 3 determines the transfer rate of the synchronization signal as B3. The management apparatus 3 generates a synchronization signal according to the transfer rate B3 of the synchronization signal and transmits the generated synchronization signal to the mobile object 2 at the transfer rate B3. In the case of “attention”, monitoring is performed by narrowing down the mobile object 2 and/or the sensor 21 as monitoring targets, so that the temporal resolution can be easily increased. In addition, the “attention” can require monitoring with increased temporal accuracy. In view of that, the transfer rate B3 can be higher than the transfer rate B1 and can be higher than the transfer rate B2. In a case where the sensor 21 is an imaging sensor, the mobile object 2 captures an image of the surrounding environment by the sensor 21 at a timing corresponding to the synchronization signal, acquires the image, and transmits transmission information including the image to the management apparatus 3 via the communication link 6. This makes it possible for the management apparatus 3 to receive the transmission information, display an image corresponding to the transmission information on the monitoring screen 31, and monitor the mobile object 2. That is, according to the fact that the task type of the remote management is “attention”, the communication amount of the transmission information can be suppressed to the communication amount according to the transfer rate B3 of the synchronization signal, making it possible to appropriately monitor the mobile object 2.

When the task type of the management of the mobile object 2 is “manipulation”, the management apparatus 3 determines the transfer rate of the synchronization signal as B4. The management apparatus 3 generates a synchronization signal according to a transfer rate B4 of the synchronization signal and transmits the generated synchronization signal to the mobile object 2 at the transfer rate B4. The “manipulation” can require control with increased temporal accuracy. In view of this point, the transfer rate B4 can be set to be higher than the transfer rate B1. In a case where the sensor 21 is an imaging sensor, the mobile object 2 captures an image of the surrounding environment by the sensor 21 at a timing corresponding to the synchronization signal, acquires the image, and transmits transmission information including the image to the management apparatus 3 via the communication link 6. This makes it possible for the management apparatus 3 to receive the transmission information, display an image corresponding to the transmission information on the monitoring screen 31, and monitor the mobile object 2. That is, according to the fact that the task type of the remote management is “manipulation”, the communication amount of the transmission information can be suppressed to the communication amount according to the transfer rate B4 of the synchronization signal, making it possible to appropriately monitor the mobile object 2.

Incidentally, although not illustrated in FIGS. 2 and 3 for simplification, an input object (for example, a button, a check box, a drop-down menu, a text box, etc.) capable of receiving an operation instruction from the user may be displayed on the monitoring screen 31 as a graphical user interface. In addition, when the task type of management of the mobile object 2 is switched, the display of the input object may be performed such that the input object is deactivated (for example, grayed-out) or hidden until an image corresponding to the task type is displayed on the monitoring screen 31, and the input object is activated or displayed after the image corresponding to the task type is displayed on the monitoring screen 31.

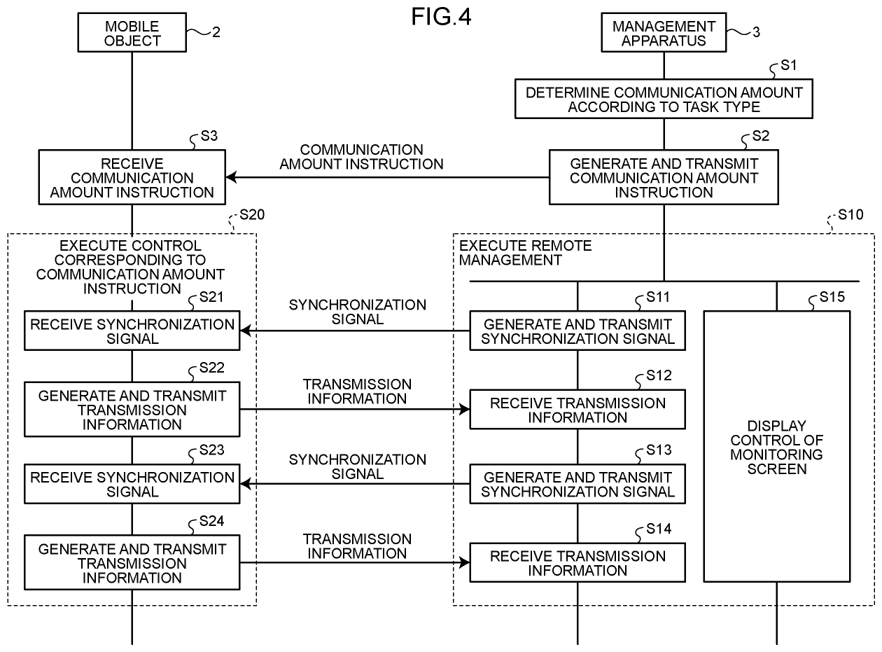

Next, a management method executed in the management system 1 will be described with reference to FIG. 4. FIG. 4 is a sequence diagram illustrating a management method. Although FIG. 4 illustrates a process between one mobile object 2 and the management apparatus 3, this similarly applies to the process between the other mobile object 2 and the management apparatus 3.

In the management system 1, the management apparatus 3 determines the communication amount between the management apparatus 3 and the mobile object 2 according to the task type of management of the mobile object 2 (S1). The management apparatus 3 may determine the communication amount of the information transmitted from the mobile object 2 to the management apparatus 3 according to the task type of management of the mobile object 2, and for example, may determine the resolution of the image data transmitted from the mobile object 2 to the management apparatus 3. The management apparatus 3 may determine the communication amount of the information transmitted from the management apparatus 3 to the mobile object 2 according to the task type of management of the mobile object 2, and for example, may determine the transfer rate of the synchronization signal transmitted from the management apparatus 3 to the mobile object 2. The management apparatus 3 generates a communication amount instruction including a request for performing communication with the communication amount determined in S1, and transmits the generated communication amount instruction to the mobile object 2 (S2).

When having received the communication amount instruction from the management apparatus 3 via the communication link 6 (S3), the mobile object 2 executes control corresponding to the communication amount instruction (S20). In S20, the processes of S21 to S24 are performed. In parallel with this, after S2, the management apparatus 3 executes remote management of the mobile object 2 (S10). In S10, the processes of S11 to S14 and the processes of S15 are performed in parallel.

For example, when the remote management (S10) of the mobile object 2 is started, the management apparatus 3 generates a synchronization signal and transmits the generated synchronization signal to the mobile object 2 at the transfer rate determined in S1 (S11). At the same time, the management apparatus 3 activates the monitoring screen 31 and starts display control (S15) of the monitoring screen 31.

When having received the synchronization signal from the management apparatus 3 via the communication link 6 (S21), the mobile object 2 captures an image of the surrounding environment with the sensor 21, and acquires an image with a resolution corresponding to the communication amount instruction. The mobile object 2 generates transmission information including image data corresponding to the acquired image and transmits the generated transmission information to the management apparatus 3 (S22).

When having received the transmission information from the mobile object 2 via the communication link 6 (S12), the management apparatus 3 displays an image corresponding to the image data included in the transmission information on the monitoring screen 31 (S15). At this time, the image can be displayed on the monitoring screen 31 at a resolution corresponding to the communication amount instruction.

According to the lapse of the predetermined cycle from S11, the management apparatus 3 generates a synchronization signal and transmits the generated synchronization signal to the mobile object 2 at the transfer rate determined in S1 (S13).

When having received the synchronization signal from the management apparatus 3 via the communication link 6 (S23), the mobile object 2 captures an image of the surrounding environment with the sensor 21, and acquires an image with a resolution corresponding to the communication amount instruction. The mobile object 2 generates transmission information including image data corresponding to the acquired image and transmits the generated transmission information to the management apparatus 3 (S24).

When having received the transmission information from the mobile object 2 via the communication link 6 (S14), the management apparatus 3 displays an image corresponding to the image data included in the transmission information on the monitoring screen 31 (S15). At this time, the image can be displayed on the monitoring screen 31 at a resolution corresponding to the communication amount instruction.

Although not illustrated, after S24, the processes similar to S21 to S24 may be repeated in the mobile object 2. After S14, the management apparatus 3 may repeat processing similar to S11 to S14 while continuing S15.

In addition, every time the task type is changed, the management apparatus 3 may return the process to S1 and perform the processes in S1 and subsequent steps.

As described above, in the first embodiment, in the management system 1, the communication amount between the management apparatus 3 and the mobile object 2 is determined according to the task type of remote management of the mobile object 2, and the communication amount instruction including the request for performing communication with the determined communication amount is transmitted to the mobile object 2. This makes it possible to suppress the communication amount of information transmitted from the mobile object 2 to the management apparatus 3 via the communication link 6 to an appropriate communication amount corresponding to the task type of management of the mobile object 2. In addition, the management apparatus 3 can suppress the communication amount of information transmitted from the management apparatus 3 to the mobile object 2 via the communication link 6 to an appropriate communication amount corresponding to the task type of management of the mobile object 2. This leads to reduction of the traffic of the communication link 6 between the management apparatus 3 and the mobile object 2. That is, it is possible to optimize the communication amount between the management apparatus 3 and the mobile object 2, and achieve suppression of a communication delay between the management apparatus 3 and the mobile object 2, enabling efficient remote management of the mobile object 2.

Note that sensor information may be displayed on the monitoring screen 31 of a management terminal 5 in addition to the image IM, and the display layout of the sensor information may be changed according to the task type.

For example, in a case where the task type of the remote management is “manipulation”, the management apparatus 3 may display a point cloud indicating a distance measurement point cloud of the distance measurement sensor by superimposing the point cloud over an image IM3 similar to the image of (d) in FIG. 3 on the monitoring screen 31.

Alternatively, in a case where the task type of the remote management is “attention”, the management apparatus 3 may perform the display such that the image IM3 similar to the image at (c) in FIG. 3 is displayed on the monitoring screen 31, but the point cloud indicating the distance measurement point cloud of the distance measurement sensor is not displayed.

Alternatively, when determining the communication amount in S1 of FIG. 4, the management apparatus 3 may determine the communication amount in consideration of a traveling environment condition of the mobile object 2. For example, the communication environment can vary depending on whether the traveling environment is a static traveling environment (such as an indoor-outdoor communication environment) or a dynamic traveling environment (such as an environment with many people due to events). Therefore, the management apparatus 3 may finely adjust the communication amount in consideration of the traveling environment condition of the mobile object 2. This makes it possible to suppress the communication amount between the management apparatus 3 and the mobile object 2 to the communication amount corresponding to the traveling environment condition of the mobile object 2 in addition to the task type of management of the mobile object 2.

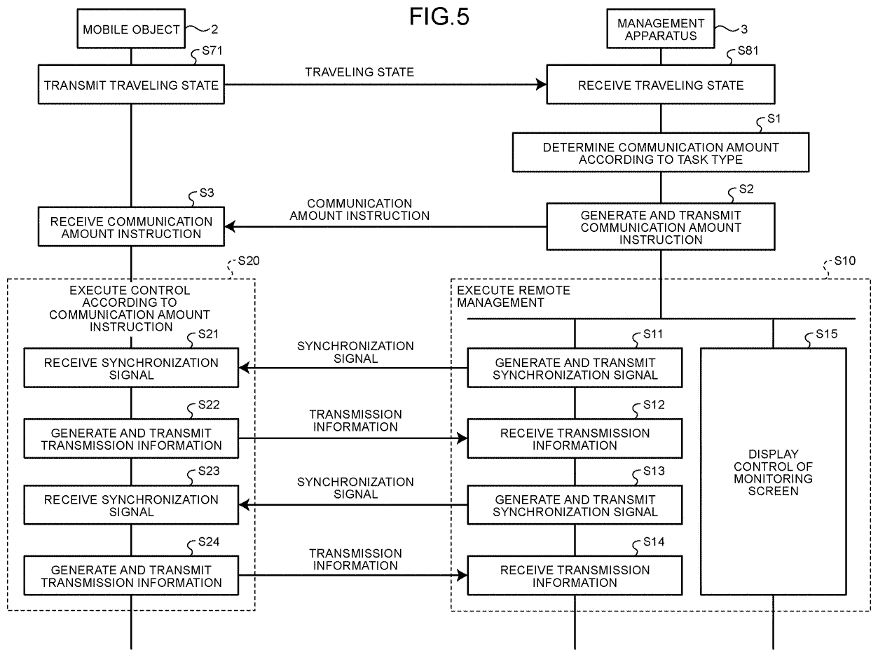

In addition, as a modification of the first embodiment, the management method executed by the management system 1 may start, as illustrated in FIG. 5, the processes in S1 and subsequent steps with a change in the traveling state of the mobile object 2 as a trigger. FIG. 5 is a sequence diagram illustrating a management method according to a modification of the first embodiment.

In the management system 1, the mobile object 2 detects a traveling state of the mobile object 2. The traveling state of the mobile object 2 includes starting of the mobile object 2, stopping of the mobile object 2, acceleration of the mobile object 2, deceleration of the mobile object 2, turning of the mobile object 2, backward movement of the mobile object 2, stopping of the mobile object 2, parking of the mobile object 2, etc. The mobile object 2 may periodically detect the traveling state of the mobile object 2 by using the signal of the sensor 21. Alternatively, the mobile object 2 may detect the traveling state of the mobile object 2 according to the occurrence of an event by using a signal of an event-driven sensor 21 such as an event camera. The mobile object 2 transmits the information regarding the traveling state to the management apparatus 3 via the communication link 6 (S71).

When the management apparatus 3 has received the information regarding the traveling state from the mobile object 2 via the communication link 6 (S81), the management apparatus 3 may compare the information regarding the traveling state with the information regarding the traveling state received immediately before from the mobile object 2 to judge whether a change in the traveling state of the mobile object 2 has occurred. Alternatively, the management apparatus 3 may judge whether a change in the traveling state of the mobile object 2 has occurred by checking the content (for example, the signal level) of the information regarding the traveling state corresponding to the occurrence of the event.

The management apparatus 3 waits until a change in the traveling state of the mobile object 2 occurs. When a change in the traveling state of the mobile object 2 occurs, the management apparatus 3 determines the communication amount between the management apparatus 3 and the mobile object 2 according to the task type of management of the mobile object 2 (S1).

For example, the management apparatus 3 may specify the traffic volume around the mobile object 2 according to the information regarding the traveling state. The traffic volume around the mobile object 2 may be the average quantity of objects around the mobile object 2 or the average speed of objects passing around the mobile object 2 per unit time. When the management apparatus 3 has judged that the specified traffic volume is larger than the predetermined volume, and when the task type of the management of the mobile object 2 is a task type with an image such as “monitoring with image”,“ manipulation”, or “attention”, the management apparatus 3 decreases the quantity of monitoring targets and increases the resolution of the image. This makes it possible to improve the quality of monitoring in correspondence with an increase in the traffic volume around the mobile object 2 while suppressing an increase in the communication amount.

Alternatively, when the management apparatus 3 has judged that the specified traffic volume becomes less than the predetermined volume, and when the task type of the management of the mobile object 2 is a task type with an image such as “monitoring with image”, “manipulation”, or “attention”, the management apparatus 3 decreases the resolution of the image. This makes it possible to reduce the quality of monitoring and to save the communication amount in correspondence with the decrease in the traffic volume around the mobile object 2.

Alternatively, when the management apparatus 3 has discovered a suspicious person around the mobile object 2 according to the information regarding the traveling state, and when the task type of the management of the mobile object 2 is a task type with an image such as “monitoring with image”, “manipulation”, or “attention”, the management apparatus 3 decreases the quantity of monitoring targets and increases the resolution of the image. This makes it possible to improve the quality of monitoring in correspondence with the discovery of the suspicious person around the mobile object 2 while suppressing an increase in the communication amount.

Alternatively, the management apparatus 3 may specify the weather around the mobile object 2 according to the information regarding the traveling state. The weather around the mobile object 2 includes clear weather, sunny weather, cloudy weather, rainy weather, snowy weather, etc. According to a change of the specified weather from bad weather (for example, cloudy weather, rainy weather, snowy weather, etc.) to good weather (for example, clear weather, sunny weather, etc.), the management apparatus 3 decreases the resolution of the image when the task type of management of the mobile object 2 is a task type with an image such as “monitoring with image”, “manipulation”, or “attention”. This makes it possible to lower the quality of monitoring in correspondence with the fact that the weather around the mobile object 2 is good and it is easy to obtain the field of view, thereby saving the communication amount.

Alternatively, according to the fact that the specified weather changes from bad weather to good weather, and in a case where the task type of the management of the mobile object 2 is the task type with the image such as “monitoring with image”, “manipulation”, or “attention”, the management apparatus 3 decreases the quantity of monitoring targets and increases the resolution of the image. This makes it possible to improve the quality of monitoring in correspondence with the fact that the weather around the mobile object 2 is not good and it is difficult to obtain a field of view while suppressing an increase in the communication amount.

Alternatively, the management apparatus 3 may specify the content of the service conducted by the mobile object 2 according to the information regarding the traveling state. The content of the service includes security monitoring, advertisement presentation, etc. According to the change of the content of the specified service from the service with low necessity of monitoring (for example, advertisement presentation, etc.) to the service with high necessity of monitoring (for example, security monitoring, etc.), and when the task type of the management of the mobile object 2 is the task type with the image such as “monitoring with image”, “manipulation”, or “attention”, the management apparatus 3 decreases the quantity of monitoring targets and increases the resolution of the image. This makes it possible to improve the quality of monitoring in correspondence with the fact that the content of the service has a high necessity of monitoring while suppressing an increase in the communication amount.

Alternatively, according to the change of the content of the specified service from the service with low necessity of monitoring to the service with high necessity of monitoring, and when the task type of the management of the mobile object 2 is the task type with an image such as “monitoring with image”, “manipulation”, or “attention”, the management apparatus 3 decreases the resolution of the image. This makes it possible to lower the quality of monitoring in correspondence with the fact that the content of the service has a low necessity of monitoring, saving the communication amount.

Thereafter, processes similar to that in FIG. 4 are performed.

### Second Embodiment

Next, a management system 101 according to a second embodiment will be described. Hereinafter, differences from the first embodiment will be mainly described.

In the second embodiment, a configuration including a server and a plurality of management terminals is exemplified as an implementation form of the management apparatus in the management system 101.

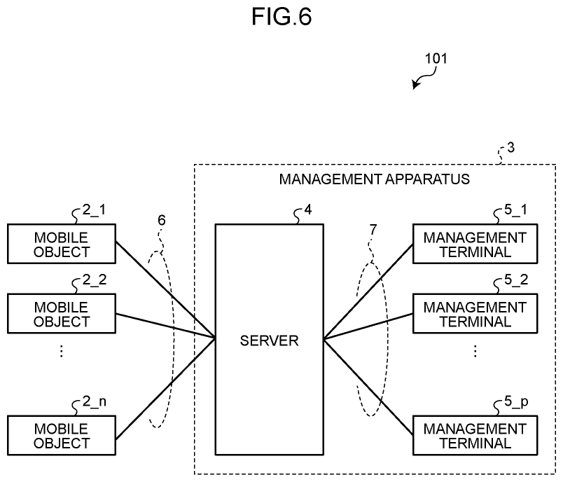

The management system 101 may have a configuration as illustrated in FIG. 6. FIG. 6 is a diagram illustrating a schematic configuration of the management system 101 according to the second embodiment.

In the management system 101, the management apparatus 3 includes a server 4 and a plurality of management terminals 5_1 to 5_p. p is an arbitrary integer of 2 or more.

The plurality of mobile objects 2_1 to 2_n are communicably connected to the server 4 via a communication link 6. The server 4 is communicably connected to the plurality of management terminals 5_1 to 5_p via a communication link 7.

The communication link 6 may be similar to the communication link 6 of the first embodiment. The communication link 7 includes a wireless communication link and/or a wired communication link. The wireless communication link includes a communication link using a Radio Access Technology (RAT) such as Long Term Evolution (LTE), New Radio (NR), Wi-Fi, and Bluetooth (registered trademark). The wired communication link includes the Internet, a Local Area Network (LAN), a telephone switching network, etc.

In the management system 101, each of the server 4 and each of the management terminals 5 may be managed by the manufacturer of the mobile object 2. Each management terminal 5 can perform remote management of the state of the mobile object 2 via the communication link 7, the server 4, and the communication link 6. Each management terminal 5 performs state monitoring and operation control of the mobile object 2.

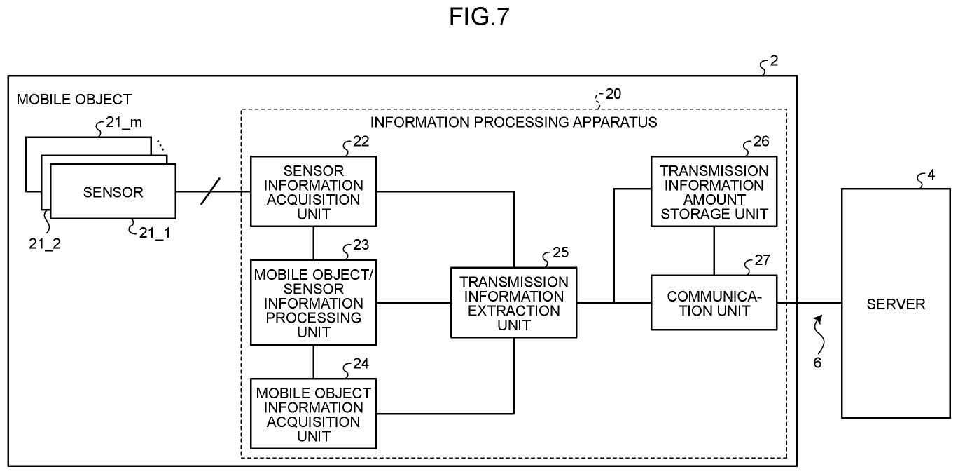

The mobile object 2 may have a functional configuration as illustrated in FIG. 7. FIG. 7 is a diagram illustrating a functional configuration of the mobile object 2.

On the mobile object 2, an information processing apparatus 20 is mounted in addition to a plurality of sensors 21_1 to 21_m. The information processing apparatus 20 includes a sensor information acquisition unit 22, a mobile object/sensor information processing unit 23, a mobile object information acquisition unit 24, a transmission information extraction unit 25, a transmission information volume storage unit 26, and a communication unit 27.

The sensor information acquisition unit 22 is connected between the plurality of sensors 21_1 to 21_m, the mobile object/sensor information processing unit 23, and the transmission information extraction unit 25. The mobile object information acquisition unit 24 is connected between the mobile object/sensor information processing unit 23 and the transmission information extraction unit 25. The transmission information extraction unit 25 is connected between the sensor information acquisition unit 22, the mobile object/sensor information processing unit 23, the mobile object information acquisition unit 24, the transmission information volume storage unit 26, and the communication unit 27. The transmission information volume storage unit 26 is connected between the transmission information extraction unit 25 and the communication unit 27. The communication unit 27 is connected between the transmission information extraction unit 25, the transmission information volume storage unit 26, and the server 4.

When the synchronization signal is received by the communication unit 27 from the server 4 via the communication link 6, the synchronization signal is supplied to each sensor 21 via the transmission information extraction unit 25 and the sensor information acquisition unit 22. In response to this, sensing operation can be performed by each sensor 21.

When the communication unit 27 has received the communication amount instruction from the server 4 via the communication link 6, the communication amount instruction is supplied to the mobile object/sensor information processing unit 23 via the transmission information volume storage unit 26. The mobile object/sensor information processing unit 23 receives a sensing result from the sensor 21 via the sensor information acquisition unit 22. The mobile object/sensor information processing unit 23 may adjust the information volume of the sensing result according to the communication amount instruction. The mobile object/sensor information processing unit 23 may adjust the information volume of the sensing result according to the communication status of the mobile object 2 and/or the surrounding information of the mobile object 2 in addition to the communication amount instruction. The surrounding information of the mobile object 2 includes that the traffic volume is large, and that it is necessary to increase sensor information, etc. for safe remote control in a case where the traffic risk is high such as when crossing an intersection. In a case where the sensing result is an image, the mobile object/sensor information processing unit 23 may adjust the resolution of the sensing result (image) according to the resolution of the image included in the communication amount instruction. Furthermore, in a case where the sensing result is an image, the mobile object/sensor information processing unit 23 may perform an image recognition process using a trained model on the image. The mobile object/sensor information processing unit 23 may include the result of the image recognition process in the sensing result as tag information.

The mobile object information acquisition unit 24 acquires mobile object information (for example, mobile object ID, etc.). The mobile object information acquisition unit 24 supplies the mobile object information to the mobile object/sensor information processing unit 23 and the transmission information extraction unit 25.

The mobile object/sensor information processing unit 23 receives mobile object information from the mobile object information acquisition unit 24. The mobile object/sensor information processing unit 23 performs predetermined processing on the mobile object information, and supplies the processed mobile object information to the transmission information extraction unit 25.

The transmission information extraction unit 25 receives the sensing results from the sensor information acquisition unit 22, receives the processed sensing results from the mobile object/sensor information processing unit 23, receives the mobile object information from the mobile object information acquisition unit 24, and receives the processed mobile object information from the mobile object/sensor information processing unit 23. The transmission information extraction unit 25 generates transmission information. The transmission information includes: a sensing result and/or a sensing result after processing; and mobile object information and/or mobile object information after processing. The transmission information extraction unit 25 may specify the information volume of the transmission information and store the specified information volume in the transmission information volume storage unit 26. The transmission information extraction unit 25 supplies the transmission information to the communication unit 27. According to this, the transmission information is transmitted to the server 4 via the communication link 6.

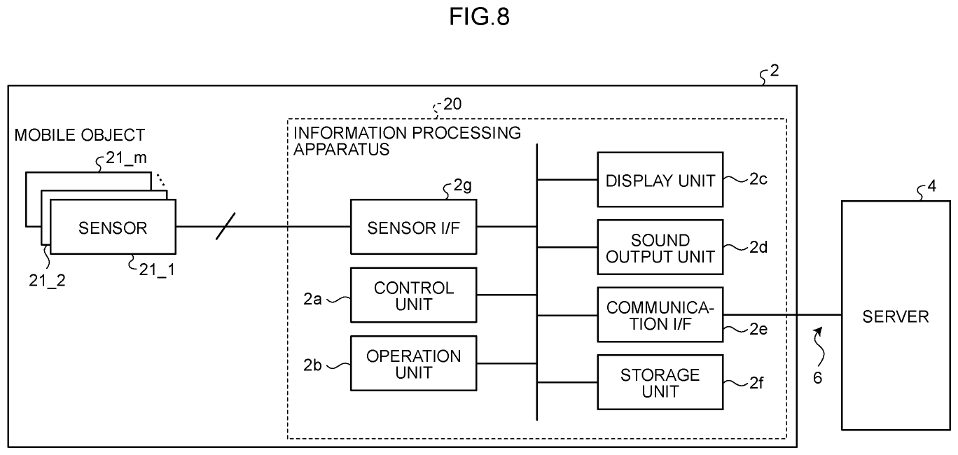

The mobile object 2 may have a hardware configuration as illustrated in FIG. 8. FIG. 8 is a diagram illustrating a hardware configuration of the mobile object 2.

The mobile object 2 includes an information processing apparatus 20 in addition to a plurality of sensors 21_1 to 21_m. The plurality of sensors 21_1 to 21_m and the information processing apparatus 20 can be communicably connected to each other via a communication path. The communication path may be a wired communication path such as a serial cable.

The information processing apparatus 20 includes a control unit 2a, an operation unit 2b, a display unit 2c, a sound output unit 2d, a communication interface (I/F) 2e, a sensor interface (I/F) 2g, and a storage unit 2f. The sensor interface (I/F) 2g, the control unit 2a, the operation unit 2b, the display unit 2c, the sound output unit 2d, the communication interface 2e, and the storage unit 2f can be communicably connected to each other via a bus.

The control unit 2a integrally controls individual units of the mobile object 2. The control unit 2a may be an Electronic Control Unit (ECU). The plurality of sensors 21_1 to 21_m is connected to the sensor interface (I/F) 2g via a communication path. The operation unit 2b receives an operation instruction from the user. In a case where the mobile object 2 is a vehicle, the operation unit 2b can include a steering wheel, an accelerator, a brake, etc. The operation unit 2b may further include a button, a key, a touch panel, etc. The display unit 2c outputs predetermined information to the user by display. The display unit 2c includes a display 30 such as an LCD. The sound output unit 2d outputs predetermined information to the user by sound. The sound output unit 2d may be a speaker. The communication interface 2e is communicably connected to the server 4 via the communication link 6. The communication interface 2e may include a reception circuit that receives information from the server 4 and a transmission circuit that transmits information to the server 4. The storage unit 2f can store information. The storage unit 2f may be a nonvolatile storage medium such as a hard disk.

For example, when a communication amount instruction including a request for performing communication with a communication amount determined according to a task type of remote management has been received by the communication interface 2e, the control unit 2a may perform control to communicate with the management apparatus 3 (server 4) with a communication amount corresponding to the communication amount instruction. The communication amount corresponding to the communication amount instruction includes the resolution of the image corresponding to the communication amount instruction. The control unit 2a may control the sensor 21 so that the quantity of pixels of the acquired image becomes the quantity of pixels corresponding to the communication amount instruction so as to allow the image having the resolution corresponding to the communication amount instruction to be acquired by the mobile object 2. Alternatively, the control unit 2a may control the quantity of pixels of the image data generated from the image acquired by the sensor 21 to be the quantity of pixels corresponding to the communication amount instruction to allow the image having the resolution corresponding to the communication amount instruction to be acquired by the mobile object 2.

In the configuration illustrated in FIG. 7, the transmission information volume storage unit 26 is implemented by the storage unit 2f. The communication unit 27 is implemented by the communication interface 2e. The sensor information acquisition unit 22 is implemented by a sensor interface 2g. Individual units (mobile object/sensor information processing unit 23, mobile object information acquisition unit 24, transmission information extraction unit 25) except the sensor 21, the transmission information volume storage unit 26, and the communication unit 27 may be implemented in software in the control unit 2a. For example, the control unit 2a may be a system including a processor, nonvolatile memory, and volatile memory. The nonvolatile memory stores a program. The processor may read the program from the nonvolatile memory and activate the program triggered by power activation, etc. of the mobile object 2, and may develop the modules corresponding to the individual units collectively at the time of compiling or sequentially on the volatile memory according to the progress of the processes. Thereby, the processor may operate according to the program. Alternatively, individual units may be implemented in hardware as a circuit configured in the control unit 2a. Alternatively, some of the individual units may be implemented as software and the others may be implemented as hardware.

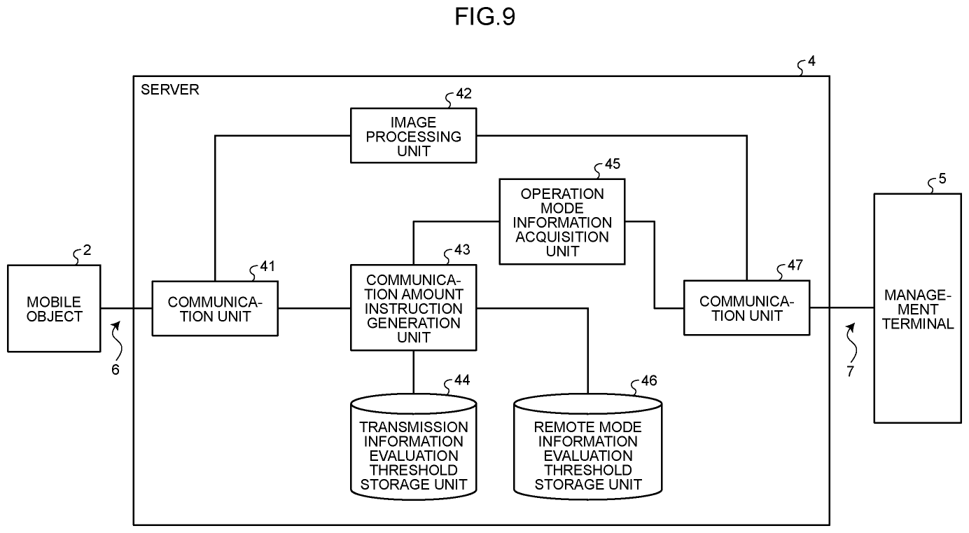

The server 4 may have a functional configuration as illustrated in FIG. 9. FIG. 9 is a diagram illustrating a functional configuration of the server 4.

The server 4 includes a communication unit 41, an image processing unit 42, a communication amount instruction generation unit 43, a transmission information evaluation threshold storage unit 44, an operation mode information acquisition unit 45, a remote mode information evaluation threshold storage unit 46, and a communication unit 47.

The communication unit 41 is connected between the mobile object 2, the image processing unit 42, and the communication amount instruction generation unit 43. The image processing unit 42 is connected between the communication unit 41 and the communication unit 47. The communication amount instruction generation unit 43 is connected between the communication unit 41, the operation mode information acquisition unit 45, the transmission information evaluation threshold storage unit 44, and the remote mode information evaluation threshold storage unit 46. The operation mode information acquisition unit 45 is connected between the communication amount instruction generation unit 43 and the communication unit 47. The communication unit 47 is connected between the image processing unit 42, the operation mode information acquisition unit 45, and the management terminal 5.

When having received a task request from the management terminal 5 via the communication link 7 and the communication unit 47, the operation mode information acquisition unit 45 specifies a task type of remote management to be executed by the management terminal 5 according to the task request, generates task information indicating the task type, and supplies the generated task information to the communication amount instruction generation unit 43. The communication amount instruction generation unit 43 determines the communication amount between the server 4 and the mobile object 2 according to the task information. The communication amount instruction generation unit 43 generates a communication amount instruction with reference to the information stored in the transmission information evaluation threshold storage unit 44 and the information stored in the remote mode information evaluation threshold storage unit 46. The communication amount instruction generation unit 43 may generate the communication amount instruction including a request for performing communication with the determined communication amount. The communication amount instruction generation unit 43 transmits the communication amount instruction to the mobile object 2 via the communication unit 41 and the communication link 6.

After transmitting the communication amount instruction, the communication amount instruction generation unit 43 periodically generates a synchronization signal. The communication amount instruction generation unit 43 transmits the synchronization signal to the mobile object 2 via the communication unit 41 and the communication link 6, and transmits the synchronization signal to the management terminal 5 via the operation mode information acquisition unit 45, the communication unit 47, and the communication link 7.

When having received the transmission information from the mobile object 2 via the communication link 6 and the communication unit 41, the communication amount instruction generation unit 43 transfers the received transmission information to the management terminal 5 via the operation mode information acquisition unit 45, the communication unit 47, and the communication link 7.

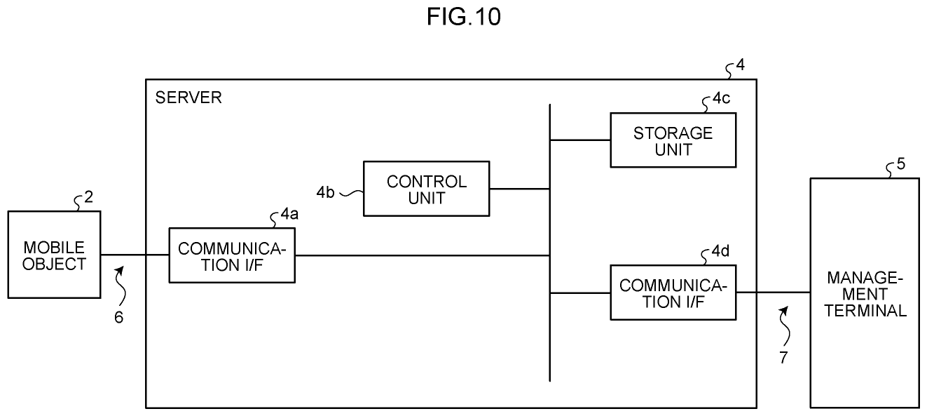

The server 4 may have a hardware configuration as illustrated in FIG. 10. FIG. 10 is a diagram illustrating a hardware configuration of the server 4.

The server 4 includes a communication interface (I/F) 4a, a control unit 4b, a storage unit 4c, and a communication interface (I/F) 4d. The communication interface 4a, the control unit 4b, the storage unit 4c, and the communication interface 4d can be communicably connected to each other via a bus.

The communication interface 4a is communicably connected to the mobile object 2 via the communication link 6. The communication interface 4a may include a reception circuit that receives information from the mobile object 2 and a transmission circuit that transmits information to the mobile object 2. The control unit 4b integrally controls individual units of the server 4. The control unit 4b may be a Central Processing Unit (CPU). The storage unit 4c can store information. The storage unit 4c may be a nonvolatile storage medium such as a hard disk. The communication interface 4d is communicably connected to the management terminal 5 via the communication link 7. The communication interface 4d may include a reception circuit that receives information from the management terminal 5 and a transmission circuit that transmits information to the management terminal 5.

In the configuration illustrated in FIG. 9, the communication unit 41 is implemented by the communication interface 4a. The transmission information evaluation threshold storage unit 44 and the remote mode information evaluation threshold storage unit 46 are implemented by the storage unit 4c. The communication unit 47 is implemented by the communication interface 4d. The individual units (image processing unit 42, communication amount instruction generation unit 43, and operation mode information acquisition unit 45) except the communication unit 41, the transmission information evaluation threshold storage unit 44, the remote mode information evaluation threshold storage unit 46, and the communication unit 47 may be implemented in software in the control unit 4b. For example, the control unit 4b may be a system including a processor, nonvolatile memory, and volatile memory. The nonvolatile memory stores a program. The processor may read the program from the nonvolatile memory and activate the program triggered by power activation, etc. of the server 4, and may develop the modules corresponding to the individual units collectively at the time of compiling or sequentially on the volatile memory according to the progress of the processes. Thereby, the processor may operate according to the program. Alternatively, individual units may be implemented in hardware as a circuit configured in the control unit 4b. Alternatively, some of the individual units may be implemented as software and the others may be implemented as hardware.

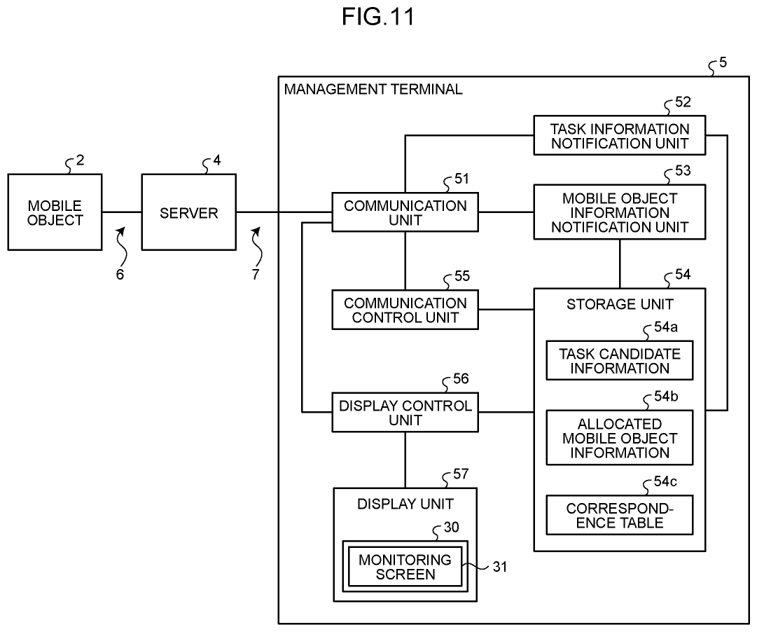

The management terminal 5 may have a functional configuration as illustrated in FIG. 11. FIG. 11 is a diagram illustrating a functional configuration of the management terminal 5.

The management terminal 5 includes a communication unit 51, a task information notification unit 52, a mobile object information notification unit 53, a storage unit 54, a communication control unit 55, a display control unit 56, and a display unit 57. The storage unit 54 stores task candidate information 54a, allocated mobile object information 54b, and a correspondence table 54c. The display unit 57 has a monitoring screen 31.

The communication unit 51 is connected between the server 4 and the task information notification unit 52, the mobile object information notification unit 53, the communication control unit 55, and the display control unit 56. The task information notification unit 52 is connected between the communication unit 51 and the storage unit 54. The mobile object information notification unit 53 is connected between the communication unit 51 and the storage unit 54. The storage unit 54 is connected between the task information notification unit 52, the mobile object information notification unit 53, the communication control unit 55, and the display control unit 56. The communication control unit 55 is connected between the communication unit 51 and the storage unit 54. The display control unit 56 is connected between the communication unit 51, the storage unit 54, and the display unit 57.

According to an instruction from the operator, the task information notification unit 52 specifies a task type of remote management executable by the management terminal 5. The task type that is executable by the management apparatus 3 may include at least one of “monitoring with image”, “monitoring without image”, “attention”, and “manipulation”. The task information notification unit 52 generates task candidate information 54a indicating a task type of remote management executable by the management terminal 5 and stores the generated task candidate information in the storage unit 54.

According to an instruction from the operator, the mobile object information notification unit 53 specifies the mobile object 2 in charge of remote management by the management terminal 5 among the plurality of mobile objects 2_1 to 2_n. The mobile object information notification unit 53 generates the allocated mobile object information 54b including the identification information of the mobile object 2 in charge of the remote management by the management terminal 5, and stores the generated allocated mobile object information in the storage unit 54.

The task information notification unit 52 may generate a correspondence table 54c in which a task type and a parameter are associated regarding a plurality of task types, according to an instruction from an operator. In the correspondence table 54c, the task type and the display size may be associated with each other regarding a plurality of task types. In the correspondence table 54c, the task type, the quantity of monitoring targets, and the display size may be associated with each other regarding a plurality of task types. In the correspondence table 54c, a task type, a layout pattern, and a display size may be associated with each other regarding a plurality of task types. In the correspondence table 54c, the task type and the synchronization signal transfer rate may be associated with each other regarding a plurality of task types.

According to an instruction from the operator, the display control unit 56 may access the storage unit 54, refer to the task candidate information 54a, and display a screen that prompts registration to the correspondence table 54c for each of the plurality of task types indicated by the task candidate information 54a on the monitoring screen 31 on the display 30 of the display unit 57. The monitoring screen 31 is a display region for monitoring on the display 30. When the registration information of the correspondence table 54c is input according to an instruction from the operator, the task information notification unit 52 may add the registration information, update the correspondence table 54c, and store the updated correspondence table in the storage unit 54. This allows the updated correspondence table 54c to be registered in the management terminal 5.

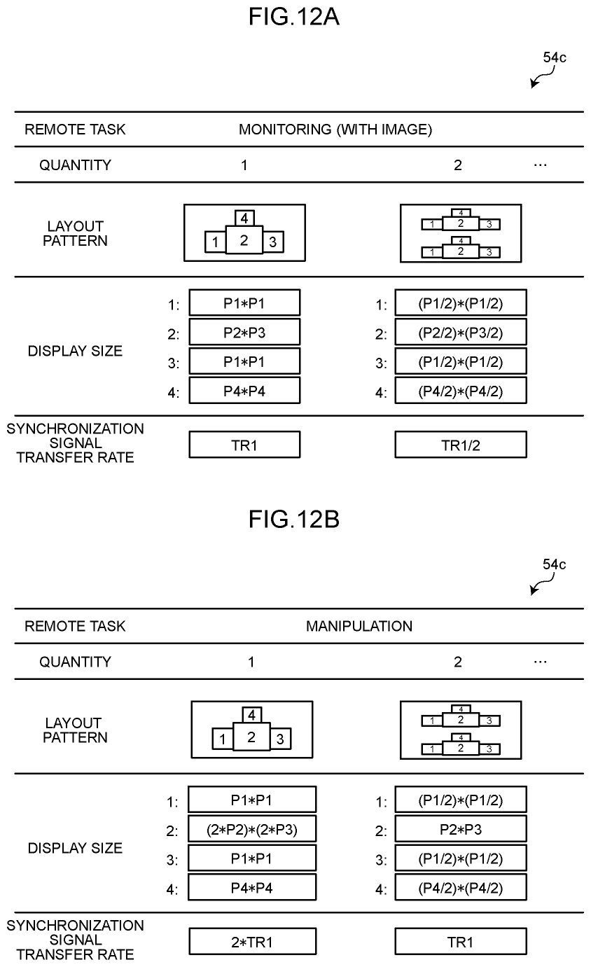

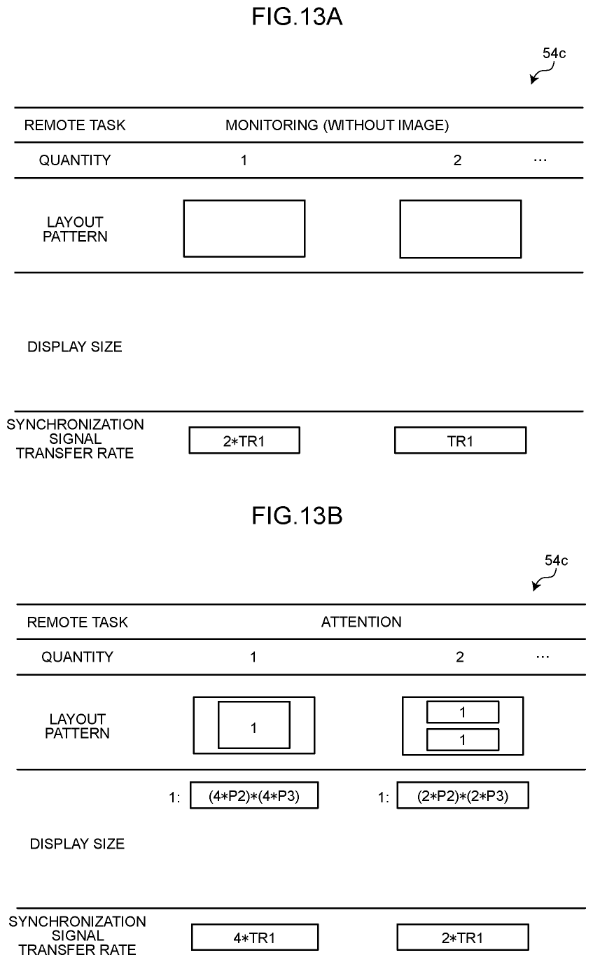

For example, the correspondence table 54c as illustrated in FIGS. 12 and 13 may be registered in the management terminal 5. FIGS. 12 and 13 are diagrams each illustrating a data structure of the correspondence table 54c. FIG. 12A illustrates a correspondence table 54c of “monitoring with image”. FIG. 12B illustrates a correspondence table 54c of “manipulation”. FIG. 13A illustrates a correspondence table 54c of “monitoring without image”. FIG. 13B illustrates a correspondence table 54c of “attention”.

FIGS. 12A to 13B each illustrate a correspondence table 54c in which a task type, the quantity of monitoring targets, a layout pattern, a display size, and a synchronization signal transfer rate are associated with each other regarding a plurality of task types.

Referring to the correspondence table 54c illustrated in FIG. 12A, it can be grasped that, regarding the “monitoring with image”, when the quantity of monitoring targets is “1”, images are displayed on the monitoring screen 31 in a layout pattern in which a main image (image “2”) is arranged at the center and sub images (images “1”, “3”, and “4”) are arranged on the left, right, and top, respectively, and the transfer rate of the synchronization signal is set to TR1. It can be grasped that the display size of the image “1” is set to the quantity of pixels P1×the quantity of pixels P1, the display size of the image “2” is set to the quantity of pixels P2×the quantity of pixels P3, the display size of the image “3” is set to the quantity of pixels P1×the quantity of pixels P1, and the display size of the image “4” is set to the quantity of pixels P4 ×the quantity of pixels P4.

Regarding the “monitoring with image”, it can be grasped that, when the quantity of monitoring targets is “2”, two image groups are vertically arranged in the monitoring screen 31 in a layout pattern in which a main image (image “2”) in each image group is displayed at the center and sub images (images “1”, “3”, and “4”) are arranged on the left, right, and top, respectively, and the transfer rate of the synchronization signal is set to TR1/2. It can be grasped that the display size of the image “1” is set to the quantity of pixels P1/2×the quantity of pixels P1/2, the display size of the image “2” is set to the quantity of pixels P2/2×the quantity of pixels P3/2, the display size of the image “3” is set to the quantity of pixels P1/2×the quantity of pixels P1/2, and the display size of the image “4” is set to the quantity of pixels P4/2×the quantity of pixels P4/2.

Referring to the correspondence table 54c illustrated in FIG. 12B, it can be grasped that, regarding the “manipulation”, when the quantity of monitoring targets is “1”, images are displayed on the monitoring screen 31 in a layout pattern in which a main image (image “2”) is displayed at the center and sub images (images “1”, “3”, and “4”) are arranged on the left, right, and top, respectively, and the transfer rate of the synchronization signal is set to 2×TR1. It can be grasped that the display size of the image “1” is set to the quantity of pixels P1×the quantity of pixels P1, the display size of the image “2” is set to the quantity of pixels (2×P2)×the quantity of pixels (2×P3), the display size of the image “3” is set to the quantity of pixels P1×the quantity of pixels P1, and the display size of the image “4” is set to the quantity of pixels P4×the quantity of pixels P4.

Regarding the “manipulation”, it can be grasped that, when the quantity of monitoring targets is “2”, two image groups are vertically arranged in the monitoring screen 31, a main image (image “2”) in each image group is displayed in a layout pattern in which sub images (images “1”, “3”, and “4”) are arranged in the center on the left, right, and top, respectively, and the transfer rate of the synchronization signal is set to TR1. It can be grasped that the display size of the image “1” is set to the quantity of pixels P1/2×the quantity of pixels P1/2, the display size of the image “2” is set to the quantity of pixels P2×the quantity of pixels P3, the display size of the image “3” is set to the quantity of pixels P1/2×the quantity of pixels P1/2, and the display size of the image “4” is set to the quantity of pixels P4/2×the quantity of pixels P4/2.

Referring to the correspondence table 54c illustrated in FIG. 13A, it can be grasped, regarding “monitoring without image”, that the transfer rate of the synchronization signal is set to 2×TR1 when the quantity of monitoring targets is “1”. Since there is no image, the fields for layout pattern and display size are blank.

It can be grasped, regarding “monitoring without image”, that the transfer rate of the synchronization signal is set to TR1 when the quantity of monitoring targets is “2”.

Referring to the correspondence table 54c illustrated in FIG. 13B, it can be grasped that, regarding “attention”, when the quantity of monitoring targets is “1”, an image is displayed on the monitoring screen 31 in a layout pattern in which the image (image “1”) is arranged at the center, and the transfer rate of the synchronization signal is set to 4×TR1. It can be grasped that the display size of the image “1” is set to the quantity of pixels (4×P2)×the quantity of pixels (4×P3).

Regarding the “attention”, it can be grasped that, when the quantity of monitoring targets is “2”, two image groups are vertically arranged in the monitoring screen 31 and displayed in a layout pattern in which an image (image “1”) is arranged at the center in each image group, and the transfer rate of the synchronization signal is set to 2×TR1. It can be grasped that the display size of the image “1” is set to the quantity of pixels (2×P2)×the quantity of pixels (2×P3).

According to an instruction from the operator, the display control unit 56 illustrated in FIG. 11 may access the storage unit 54, refer to the task candidate information 54a, and display a screen that prompts selection of one of the plurality of task types indicated by the task candidate information 54a on the monitoring screen 31 of the display unit 57. When having received a task type selection instruction from the operator, the task information notification unit 52 accesses the storage unit 54, refers to the correspondence table 54c, and extracts information (refer to FIGS. 12 and 13) corresponding to the task type corresponding to the selection instruction. The task information notification unit 52 accesses the storage unit 54 and acquires the allocated mobile object information 54b. The task information notification unit 52 generates a task request including information identifying the management terminal 5, a task type, information corresponding to the task type, and the allocated mobile object information 54b, and transmits the generated task request to the server 4 via the communication unit 51 and the communication link 7.

When the communication unit 51 receives the communication amount instruction from the server 4 via the communication link 7, the communication amount instruction is supplied to the communication control unit 55. According to the communication amount instruction, the communication control unit 55 may adjust the communication amount handled by the communication unit 51.

When the synchronization signal is received by the communication unit 51 from the server 4 via the communication link 7, the synchronization signal is supplied to the display control unit 56. According to this, the display control unit 56 can update the image on the monitoring screen 31 of the display unit 57 at a timing corresponding to the synchronization signal.

When the transmission information is received by the communication unit 51 from the server 4 via the communication link 7, the transmission information is supplied to the display control unit 56. According to this, the display control unit 56 can display an image corresponding to the image data included in the transmission information on the monitoring screen 31 of the display unit 57.

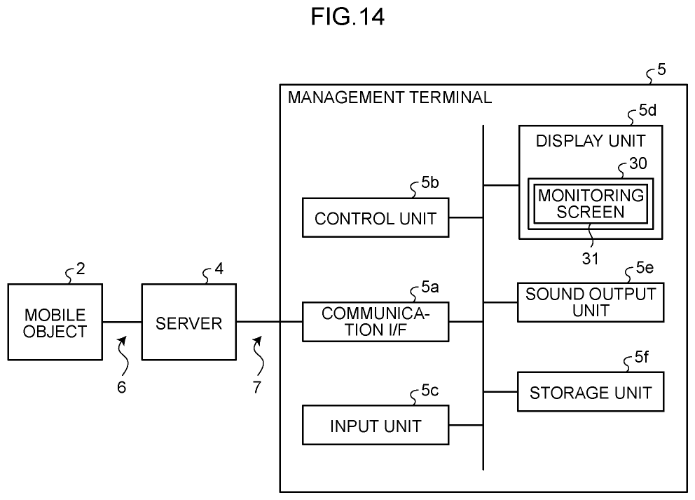

The management terminal 5 may have a hardware configuration as illustrated in FIG. 14. FIG. 14 is a diagram illustrating a hardware configuration of the management terminal 5.

The management terminal 5 includes a communication interface (I/F) 5a, a control unit 5b, an input unit 5c, a display unit 5d, a sound output unit 5e, and a storage unit 5f. The communication interface 5a, the control unit 5b, the input unit 5c, the display unit 5d, the sound output unit 5e, and the storage unit 5f can be communicably connected to each other via a bus.

The communication interface 5a is communicably connected to the server 4 via the communication link 7. The communication interface 5a may include a reception circuit that receives information from the server 4 and a transmission circuit that transmits information to the server 4. The control unit 5b integrally controls individual units of the management terminal 5. The control unit 5b may be a CPU. The input unit 5c receives an instruction from the user. The input unit 5c may include a button, a key, a touch panel, a mouse, a touch pad, a sound input apparatus, etc. The display unit 5d outputs predetermined information to the user by display. The display unit 5d includes a display 30 such as an LCD. The display 30 includes the monitoring screen 31. The monitoring screen 31 is a display region for monitoring on the display 30. The sound output unit 5e outputs predetermined information to the user by sound. The sound output unit 5e may be a speaker. The storage unit 5f can store information. The storage unit 5f may be a nonvolatile storage medium such as a hard disk.

In the configuration illustrated in FIG. 11, the communication unit 51 is implemented by the communication interface 5a. The display unit 57 is implemented by the display unit 5d. The storage unit 54 is implemented by the storage unit 5f. Individual units (task information notification unit 52, mobile object information notification unit 53, communication control unit 55, and display control unit 56) except for the communication unit 51, the display unit 57, and the storage unit 54 may be implemented in software in the control unit 5b. For example, the control unit 5b may be a system including a processor, nonvolatile memory, and volatile memory. The nonvolatile memory stores a program. The processor may read the program from the nonvolatile memory and activate the program triggered by power activation, etc. of the management terminal 5, and may develop the modules corresponding to the individual units collectively at the time of compiling or sequentially on the volatile memory according to the progress of the processes. Thereby, the processor may operate according to the program. Alternatively, individual units may be implemented in hardware as a circuit configured in the control unit 5b. Alternatively, some of the individual units may be implemented as software and the others may be implemented as hardware.

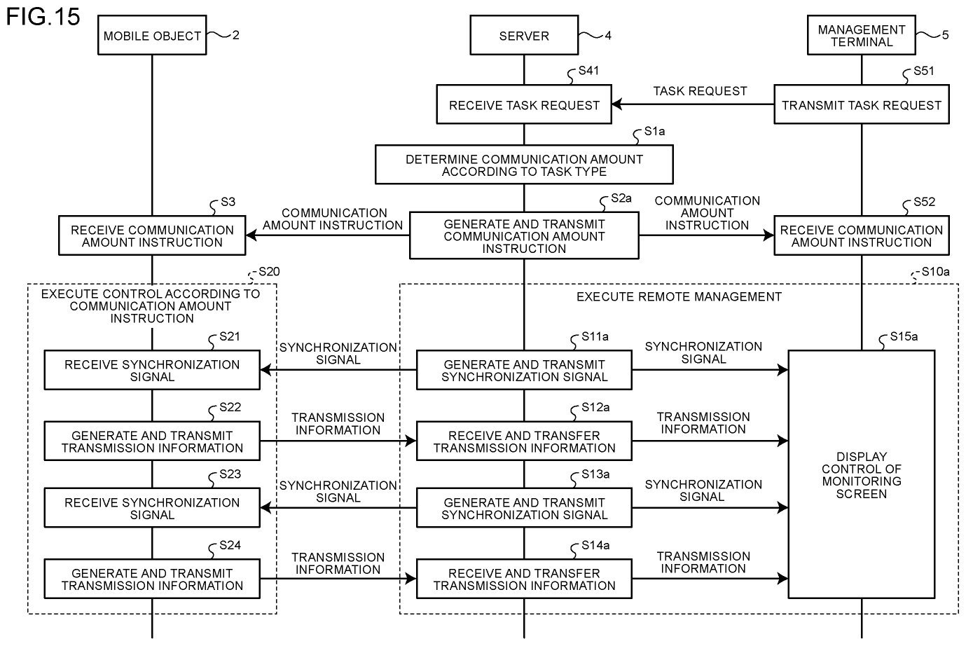

Next, a management method executed in the management system 101 will be described with reference to FIG. 15. FIG. 15 is a sequence diagram illustrating a management method. While FIG. 15 illustrates processes between one mobile object 2, the server 4, and one management terminal 5, this similarly applies to processes between another mobile object 2, the server 4, and another management terminal 5.

In the management system 101, the management terminal 5 generates a task request and transmits the generated task request to the server 4 according to an instruction from the operator (S51). The task request includes information for identifying the management terminal 5, a task type, information corresponding to the task type (refer to FIGS. 12 and 13), and the allocated mobile object information 54b.

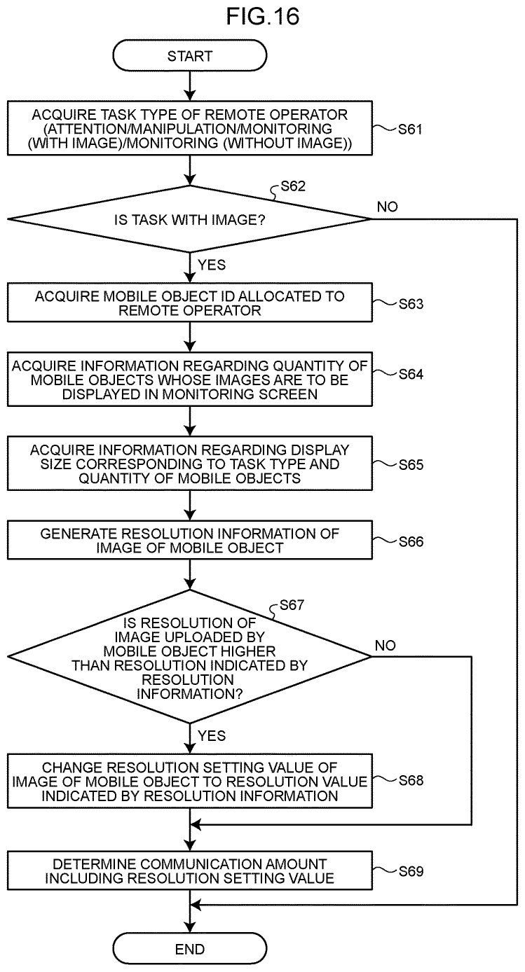

When having received the task request from the management terminal 5 via the communication link 7 (S41), the server 4 determines the communication amount between the management apparatus 3 and the mobile object 2 according to the task type included in the task request (S1a). In S1a, S61 to S69 illustrated in FIG. 16 may be performed. FIG. 16 is a flowchart illustrating a communication amount determination process.

The server 4 extracts, from the task request, information identifying the management terminal 5 and information regarding the task type. This allows the server 4 to acquire information of the task type requested by the operator of the management terminal 5 (S61).

The server 4 judges whether the task type acquired in S61 is a task with image (S62). When the task type is “monitoring without image”, the server 4 can judge that the task type is not a task with image (No in S62). When the task type is one of “monitoring with image”, “attention”, and “manipulation”, the server 4 can judge that the task type is a task with image (Yes in S62).

When the task type is not a task with image (No in S62), the server 4 ends the process.

When the task type is a task with image (Yes in S62), the server 4 extracts, from the task request, information identifying the management terminal 5 and the allocated mobile object information 54b. The server 4 extracts identification information (ID) of the mobile object 2 from the allocated mobile object information 54b. This allows the server 4 to acquire the identification information (ID) of the mobile object 2 allocated to the operator of the management terminal 5 (S63).

According to the identification information (ID) of the mobile objects 2 acquired in S63, the server 4 acquires information regarding the quantity of mobile objects 2 whose images are to be displayed on the monitoring screen 31 (S64). The server 4 may count the quantity of pieces of identification information (IDs) of the mobile objects 2 to acquire the information regarding the quantity of mobile objects 2 whose images are to be displayed.

The server 4 extracts information corresponding to the task type from the task request. The server 4 extracts information corresponding to the quantity acquired in S64 from among the extracted information. This allows the server 4 to acquire information of the display size corresponding to the task type acquired in S61 and the quantity acquired in S64 (S65).

According to the display size acquired in S65, the server 4 determines the resolution of the image of the mobile object 2 to be displayed in the monitoring screen 31 of the management terminal 5, and generates resolution information including the determined resolution (S66).

The server 4 compares the resolution of the image uploaded from the mobile object 2 immediately before with the resolution indicated by the resolution information.

When the resolution of the image uploaded from the mobile object 2 is higher than the resolution indicated by the resolution information (Yes in S67), the server 4 changes the resolution setting value of the image of the mobile object 2 to the resolution value indicated by the resolution information (S68).

When the resolution of the image uploaded from the mobile object 2 is equal to or lower than the resolution indicated by the resolution information (No in S67), the server 4 keeps the resolution setting value of the image of the mobile object 2.

The server 4 determines other parameters related to communication (for example, the transfer rate of the synchronization signal), and determines the communication amount including the resolution setting value and the other parameters (S69).

Referring back to FIG. 15, the server 4 generates a communication amount instruction including a request for performing communication with the communication amount determined in S1a, and transmits the generated communication amount instruction individually to the mobile object 2 and the management terminal 5 (S2a).

When having received the communication amount instruction from the server 4 via the communication link 6 (S3), the mobile object 2 executes control corresponding to the communication amount instruction (S20). In S20, the processes of S21 to S24 are performed. In parallel with this, the management terminal 5 receives the communication amount instruction from the server 4 via the communication link 7 (S52). After S2a and S52, the server 4 and the management terminal 5 cooperatively execute remote management of the mobile object 2 (S10a). In S10a, the processes of S11a to S14a in the server 4 and the process of S15a in the management terminal 5 are performed in parallel.

For example, when the remote management (S10a) of the mobile object 2 is started, the server 4 generates a synchronization signal and transmits the generated synchronization signal individually to the mobile object 2 and the management terminal 5 at the transfer rate determined in S1a (S11a). Together with this, the management terminal 5 activates the monitoring screen 31 on the display 30 and starts display control of the monitoring screen 31 (S15a). The monitoring screen 31 is a display region on the display 30.

When having received the synchronization signal from the server 4 via the communication link 6 (S21), the mobile object 2 captures an image of the surrounding environment with the sensor 21, and acquires an image with a resolution corresponding to the communication amount instruction. The mobile object 2 generates transmission information including image data corresponding to the acquired image and transmits the generated transmission information to the server 4 (S22). In parallel with this, the management terminal 5 receives the synchronization signal from the server 4 via the communication link 7.

When having received the transmission information from the mobile object 2 via the communication link 6, the server 4 transfers the received transmission information to the management terminal 5 via the communication link 7 (S12a). The management terminal 5 displays an image corresponding to the image data included in the transmission information on the monitoring screen 31 (S15a). At this time, the image can be displayed on the monitoring screen 31 at a resolution corresponding to the communication amount instruction received in S52. The management terminal 5 may update and display the image on the monitoring screen 31 so as to be updated at a timing corresponding to the synchronization signal.

According to the lapse of the predetermined cycle from S11a, the server 4 generates a synchronization signal and transmits the generated synchronization signal individually to the mobile object 2 and the management terminal 5 at the transfer rate determined in S1a (S13a).

When having received the synchronization signal from the management apparatus 3 via the communication link 6 (S23), the mobile object 2 captures an image of the surrounding environment with the sensor 21, and acquires an image with a resolution corresponding to the communication amount instruction. The mobile object 2 generates transmission information including image data corresponding to the acquired image and transmits the generated transmission information to the management apparatus 3 (S24). In parallel with this, the management terminal 5 receives the synchronization signal from the server 4 via the communication link 7.

When having received the transmission information from the mobile object 2 via the communication link 6, the server 4 transfers the received transmission information to the management terminal 5 via the communication link 7 (S14a). The management terminal 5 displays an image corresponding to the image data included in the transmission information on the monitoring screen 31 (S15a). At this time, the image can be displayed on the monitoring screen 31 at a resolution corresponding to the communication amount instruction received in S52. The management terminal 5 may update and display the image on the monitoring screen 31 so as to be updated at a timing corresponding to the synchronization signal.

Although not illustrated, after S24, the processes similar to S21 to S24 may be repeated in the mobile object 2. After S14a, processes similar to S11a to S14a may be repeated in the server 4 while S15a is continued in the management terminal 5.

In addition, every time a new task request is transmitted by the management terminal 5 (S51) and received by the server 4 (S41), the processes in S1a and subsequent steps may be performed in the management system 101.

As described above, in the second embodiment, in the management system 101, the communication amount between the server 4 and the mobile object 2 is determined according to the task type of remote management of the mobile object 2, and the communication amount instruction including the request for performing communication with the determined communication amount is transmitted to the mobile object 2. This makes it possible to suppress the communication amount of information transmitted from the mobile object 2 to the server 4 via the communication link 6 to an appropriate communication amount corresponding to the task type of management of the mobile object 2. In addition, the server 4 can suppress the communication amount of information transmitted from the server 4 to the mobile object 2 via the communication link 6 to an appropriate communication amount corresponding to the task type of management of the mobile object 2. This leads to reduction of the traffic of the communication link 6 between the server 4 and the mobile object 2. That is, it is possible to optimize the communication amount between the server 4 and the mobile object 2, achieving suppression of a communication delay between the server 4 and the mobile object 2.

In the management terminal 5 of the management system 101, the mobile object 2 to be monitored may be manually selected by the operator from the plurality of mobile objects 2_1 to 2_n. For example, immediately before S51 in FIG. 15, the management terminal 5 may display, on the monitoring screen 31, a screen that prompts the selection of the mobile object 2 to be a monitoring target among the plurality of mobile objects 2_1 to 2_n. When having received the selection of the mobile object 2 to be a monitoring target from the operator, the management terminal 5 generates, regarding the received mobile object 2, the allocated mobile object information 54b including identification information of the mobile object 2 in charge of remote management by the management terminal 5, and stores the generated allocated mobile object information 54b in the storage unit 54. In S51 of FIG. 15, the management terminal 5 may generate a task request for each mobile object 2 included in the allocated mobile object information 54b and transmit the generated task request to the server 4 according to an instruction from the operator. This makes it possible to determine the mobile object 2 to be a monitoring target according to manual selection by the operator and generate a task request.

Alternatively, in the management terminal 5 of the management system 101, the mobile object 2 to be monitored may be automatically selected from the plurality of mobile objects 2_1 to 2_n according to the control of the management system 101. For example, immediately before S51 in FIG. 15, the management terminal 5 determines a task type of monitoring to be performed by the management terminal 5 under the control of the management system 101, and specifies the mobile object 2 corresponding to the determined task type among the plurality of mobile objects 2_1 to 2_n. At this time, the management terminal 5 may display the specified mobile object 2 as the monitoring target on the monitoring screen 31. The management terminal 5 generates, regarding the specified mobile object 2, the allocated mobile object information 54b including the identification information of the mobile object 2 in charge of remote management by the management terminal 5, and stores the generated allocated mobile object information 54b in the storage unit 54. In S51 of FIG. 15, the management terminal 5 may generate a task request for each mobile object 2 included in the allocated mobile object information 54b and transmit the generated task request to the server 4 according to an instruction from the operator. This makes it possible to determine the mobile object 2 to be a monitoring target and generate a task request according to the control by the management system 101 in the management terminal 5.

Alternatively, in the server 4 of the management system 101, the mobile object 2 to be monitored by the management terminal 5 may be automatically selected from the plurality of mobile objects 2_1 to 2_n according to the control of the management system 101.

For example, immediately before S51 in FIG. 15, the server 4 acquires information related to a traveling environment condition from each of the plurality of mobile objects 2_1 to 2_n under the control of the management system 101. The server 4 may specify the mobile object 2 having a relatively high necessity of monitoring among the plurality of mobile objects 2_1 to 2_n according to the information related to the traveling environment condition of each mobile object 2. The server 4 may specify the mobile object 2 having a large surrounding traffic volume or a large quantity of surrounding people as the mobile object 2 having a relatively high necessity of monitoring according to the information related to the traveling environment condition of each mobile object 2.

Alternatively, under the control of the management system 101, the server 4 may manage the monitoring history of each of the plurality of mobile objects 2_1 to 2_n. The server 4 may specify the mobile object 2 having a relatively high necessity of monitoring among the plurality of mobile objects 2_1 to 2_n according to the monitoring history of each mobile object 2. The server 4 may specify the mobile object 2 having a relatively high intervention rate of the remote “manipulation” as the mobile object 2 having a relatively high necessity of monitoring according to the monitoring history of each mobile object 2.

The server 4 may notify the management terminal 5 of the mobile object 2 specified as having a relatively high necessity of monitoring as the mobile object 2 to be a monitoring target. The management terminal 5 may display, on the monitoring screen 31, the notified mobile object 2 as a monitoring target. When the mobile object 2 to be a monitoring target is notified, the management terminal 5 generates, regarding the notified mobile object 2, the allocated mobile object information 54b including the identification information of the mobile object 2 in charge of remote management by the management terminal 5, and stores the generated allocated mobile object information 54b in the storage unit 54. In S51 of FIG. 15, the management terminal 5 may generate a task request for each mobile object 2 included in the allocated mobile object information 54b and transmit the generated task request to the server 4 according to an instruction from the operator. This makes it possible to determine the mobile object 2 to be a monitoring target and generate a task request according to the control by the management system 101 in the server 4.

In addition, in the management terminal 5 of the management system 101, the mobile object 2 to be subjected to monitoring termination may be manually selected by the operator from among one or more mobile objects 2 being the monitoring targets. For example, in the management system 101, it is assumed that the mobile object 2 executes control (S20 in FIG. 15) corresponding to the communication amount instruction similarly to the second embodiment, and the server 4 and the management terminal 5 cooperatively execute remote management (S10a in FIG. 15) of the mobile object 2 similarly to the second embodiment. The management terminal 5 may display, on the monitoring screen 31, a screen that prompts selection of the mobile object 2 to be subjected to monitoring termination from among one or more mobile objects 2 being monitoring targets. When having received the selection of the mobile object 2 to be subjected to monitoring termination from the operator, the management terminal 5 may delete the identification information of the mobile object 2 from the allocated mobile object information 54b, generate a termination request including information identifying the management terminal 5 and information identifying the mobile object 2 to be subjected to monitoring termination, and transmit the generated termination request to the server 4. When having received the termination request, the server 4 terminates the remote management of the mobile object 2 (S10a in FIG. 15) in cooperation with the management terminal 5. Together with this, the server 4 transmits the termination request to the corresponding mobile object 2 according to the information identifying the mobile object 2 to be subjected to monitoring termination included in the termination request. When having received the termination request, the mobile object 2 terminates the control corresponding to the communication amount instruction (S20 in FIG. 15) according to the termination request. This makes it possible to determine the mobile object 2 to be subjected to monitoring termination according to the manual selection of the operator and terminate the monitoring.

Alternatively, in the management terminal 5 of the management system 101, the mobile object 2 to be subjected to monitoring termination may be automatically selected from among one or more mobile objects 2 being the monitoring targets according to the control of the management system 101. For example, in the management system 101, it is assumed that the mobile object 2 executes control (S20 in FIG. 15) corresponding to the communication amount instruction similarly to the second embodiment, and the server 4 and the management terminal 5 cooperatively execute remote management (S10a in FIG. 15) of the mobile object 2 similarly to the second embodiment. Under the control of the management system 101, the management terminal 5 determines a task type to be completed among task types implemented by the management terminal 5, and specifies the mobile object 2 corresponding to the task type determined among the plurality of mobile objects 2_1 to 2_n. At this time, the management terminal 5 may display the specified mobile object 2 as the monitoring termination target on the monitoring screen 31. Regarding the specified mobile object 2, the management terminal 5 may delete the identification information of the mobile object 2 from the allocated mobile object information 54b, generate a termination request including information identifying the management terminal 5 and information identifying the mobile object 2 to be subjected to monitoring termination, and transmit the generated termination request to the server 4. When having received the termination request, the server 4 terminates the remote management of the mobile object 2 (S10a in FIG. 15) in cooperation with the management terminal 5. Together with this, the server 4 transmits the termination request to the corresponding mobile object 2 according to the information identifying the mobile object 2 to be subjected to monitoring termination included in the termination request. When having received the termination request, the mobile object 2 terminates the control corresponding to the communication amount instruction (S20 in FIG. 15) according to the termination request. This makes it possible to determine the mobile object 2 to be subjected to monitoring termination according to the control by the management system 101 in the management terminal 5 and to terminate the monitoring.

Alternatively, in the server 4 of the management system 101, the mobile object 2 to be subjected to monitoring termination on the management terminal 5 may be automatically selected from among one or more mobile objects 2 being the monitoring targets according to the control of the management system 101.

For example, in the management system 101, it is assumed that the mobile object 2 executes control (S20 in FIG. 15) corresponding to the communication amount instruction similarly to the second embodiment, and the server 4 and the management terminal 5 cooperatively execute remote management (S10a in FIG. 15) of the mobile object 2 similarly to the second embodiment.

For example, under the control of the management system 101, the server 4 acquires information related to the traveling environment condition from each of the plurality of mobile objects 2_1 to 2_n. The server 4 may specify the mobile object 2 having a relatively low necessity of monitoring among the plurality of mobile objects 2_1 to 2_n according to the information related to the traveling environment condition of each mobile object 2. The server 4 may specify the mobile object 2 having a small traffic volume of surrounding mobile objects or a small quantity of surrounding people as the mobile object 2 having a relatively low necessity of monitoring according to the information related to the traveling environment condition of each mobile object 2.

Alternatively, under the control of the management system 101, the server 4 may manage the monitoring history of each of the plurality of mobile objects 2_1 to 2_n. The server 4 may specify the mobile object 2 having a relatively low necessity of monitoring among the plurality of mobile objects 2_1 to 2_n according to the monitoring history of each mobile object 2. The server 4 may specify the mobile object 2 having a relatively low intervention rate of the remote “manipulation” as the mobile object 2 having a relatively low necessity of monitoring according to the monitoring history of each mobile object 2.

The server 4 may notify the management terminal 5 of the mobile object 2 specified as having a relatively low necessity of monitoring as the mobile object 2 to be a monitoring target. The management terminal 5 may display, on the monitoring screen 31, the notified mobile object 2 as a monitoring termination target. Regarding the notified mobile object 2, the management terminal 5 may delete the identification information of the mobile object 2 from the allocated mobile object information 54b, generate a termination request including information identifying the management terminal 5 and information identifying the mobile object 2 to be subjected to monitoring termination, and transmit the generated termination request to the server 4. When having received the termination request, the server 4 terminates the remote management of the mobile object 2 (S10a in FIG. 15) in cooperation with the management terminal 5. Together with this, the server 4 transmits the termination request to the corresponding mobile object 2 according to the information identifying the mobile object 2 to be subjected to monitoring termination included in the termination request. When having received the termination request, the mobile object 2 terminates the control corresponding to the communication amount instruction (S20 in FIG. 15) according to the termination request. This makes it possible to determine the mobile object 2 to be subjected to monitoring termination according to the control by the management system 101 in the management terminal 5 and to terminate the monitoring.

Alternatively, in a case where the task is completed and/or excluded from the task target in the server 4 of the management system 101, the server 4 may generate a communication amount instruction including an instruction to change the content of the transmission information to be transmitted from the mobile object 2 to the server 4 according to at least one of: the task type included in the task request received in S41; the traveling area of the mobile object 2; and the content of the operation service by the mobile object 2, and may transmit the generated communication amount instruction to the mobile object 2 and/or the management terminal 5.

For example, when the task type included in the task request received in S41 is “manipulation”, the server 4 may generate a communication amount instruction further including a request for transmitting transmission information including image information, mobile object state information, environment sensor information, and position information, and may transmit the generated communication amount instruction to the mobile object 2.

Alternatively, when the task type included in the task request received in S41 is “attention”, the server 4 may generate a communication amount instruction further including a request for transmitting transmission information including image information, mobile object state information, and position information, and may transmit the generated communication amount instruction to the mobile object 2.

Alternatively, when the task type included in the task request received in S41 is “monitoring without image” and the traveling area of the mobile object 2 is an area with a good communication environment, the server 4 may generate a communication amount instruction further including a request for transmitting transmission information including mobile object state information, position information, and drivability related information, and may transmit the generated communication amount instruction to the mobile object 2. The drivability related information includes information related to factors affecting the drivability (for example, obstacle information, construction information, event information, etc.), and can be used as reference information when another mobile object 2 travels.

Alternatively, when the task type included in the task request received in S41 is “monitoring without image” and the traveling area of the mobile object 2 is an area with a poor communication environment, the server 4 may generate a communication amount instruction further including a request for transmitting transmission information including mobile object state information, and position information, and may transmit the generated communication amount instruction to the mobile object 2.

Alternatively, in a case where the task type included in the task request received in S41 indicates transition from “monitoring with image” to “monitoring without image”, the server 4 may generate a communication amount instruction further including a display control request when an image is hidden, and may transmit the generated communication amount instruction to the management terminal 5. The server 4 may generate a communication amount instruction further including a display control request for suppressing a movement of a location of an image of another mobile object in a case where the image is hidden, and may transmit the generated communication amount instruction to the management terminal 5. When the image is automatically hidden, the server 4 may generate a communication amount instruction further including a display control request for hiding the image after issuing a message “delete after X seconds”, and may transmit the generated communication amount instruction to the management terminal 5. The server 4 may generate a communication amount instruction further including a display control request for automatically detecting that there is no problem if an image is hidden when the image is to be manually hidden and displaying a message to that effect, and thereafter displaying a screen prompting a manual operation to hide the image, and may transmit the generated communication amount instruction to the management terminal 5.

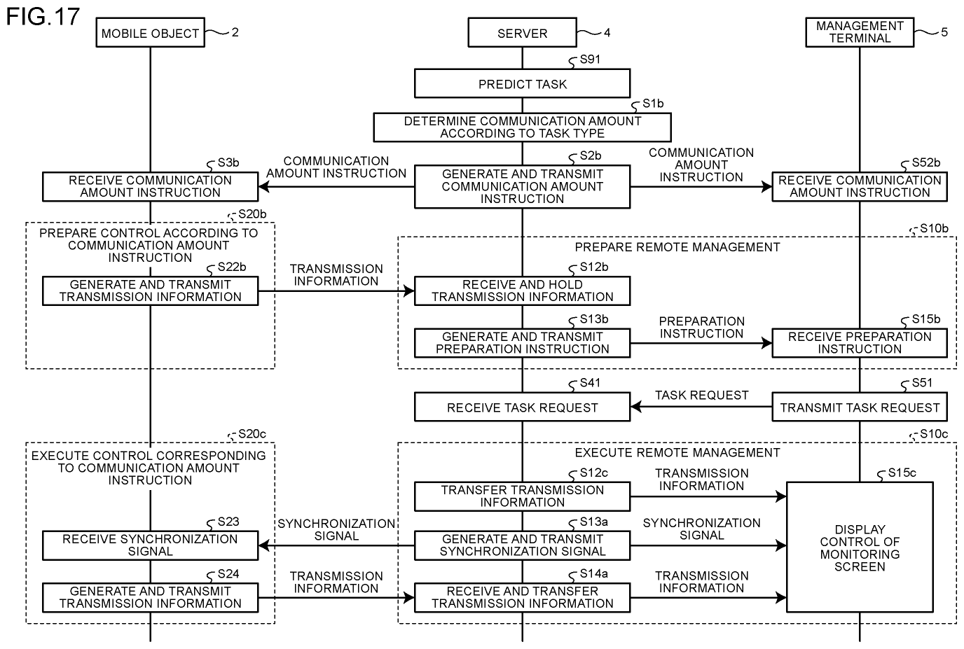

Alternatively, as a first modification of the second embodiment, the management method executed by the management system 101, as illustrated in FIG. 17, may predict a task and determine the communication amount according to a task type of the predicted task. FIG. 17 is a sequence diagram illustrating a management method according to the first modification of the second embodiment. While FIG. 17 illustrates processes between one mobile object 2, the server 4, and one management terminal 5, this similarly applies to processes between another mobile object 2, the server 4, and another management terminal 5.

In the management system 101, the server 4 predicts a task (S91). The server 4 may accumulate the past remote task history in advance and predict the task based on the past remote task history. The server 4 may acquire travel information from the mobile object 2 in advance and predict a task based on the travel information. The travel information may include at least one of information related to the position of the mobile object 2, map information, and information related to the surrounding environment of the mobile object 2. The server 4 may predict the task based on the past remote task history and the travel information.

When a task is predicted, the server 4 specifies a task type of the predicted task. The server 4 determines the communication amount between the management apparatus 3 and the mobile object 2 according to the task type of the predicted task (S1b). In S1b, processes similar to those in S61 to S69 illustrated in FIG. 16 may be performed.

The server 4 generates a communication amount instruction including a request for performing communication with the communication amount determined in S1b, and transmits the generated communication amount instruction individually to the mobile object 2 and the management terminal 5 individually (S2b).

When having received the communication amount instruction from the server 4 via the communication link 6 (S3b), the mobile object 2 prepares control corresponding to the communication amount instruction (S20b). In S20b, the process of S22b is performed. In parallel with this, the management terminal 5 receives the communication amount instruction from the server 4 via the communication link 7 (S52b). After S2b and S52b, the server 4 and the management terminal 5 cooperatively prepare for remote management of the mobile object 2 (S10b). In S10b, the processes of S12b to S13b in the server 4 and the process of S15b in the management terminal 5 are performed in parallel.

For example, according to the communication amount instruction received in S3b, the mobile object 2 captures an image of the surrounding environment by the sensor 21, and acquires an image with resolution corresponding to the communication amount instruction. The mobile object 2 generates transmission information including image data corresponding to the acquired image and transmits the generated transmission information to the server 4 (S22b).

When having received the transmission information from the mobile object 2 via the communication link 6, the server 4 holds the received transmission information (S12b). According to the holding of the transmission information, the server 4 generates a preparation instruction of instructing preparation of monitoring and transmits the generated preparation instruction to the management terminal 5 (S13b).

When having received the preparation instruction from the server 4 via the communication link 6 (S15b), the management terminal 5 activates the monitoring screen 31 according to the preparation instruction and enables the start of the display control of the monitoring screen 31.

According to an instruction from the operator, the management terminal 5 generates a task request and transmits the generated task request to the server 4 (S51). The task request includes information for identifying the management terminal 5, a task type, information corresponding to the task type (refer to FIGS. 12 and 13), and the allocated mobile object information 54b.

When the server 4 receives the task request from the management terminal 5 via the communication link 7 (S41), the server 4 and the management terminal 5 cooperatively perform remote management of the mobile object 2 (S10c). In S10c, the processes of S12c to S14a in the server 4 and the process of S15c in the management terminal 5 are performed in parallel. According to this, the mobile object 2 executes control corresponding to the communication amount instruction (S20c). In S20c, the processes of S23 to S24 are performed.

For example, when the remote management (S10c) of the mobile object 2 is started, the server 4 transfers the held transmission information to the management terminal 5 via the communication link 7 (S12c). The management terminal 5 is enabled to start the display control of the monitoring screen 31. When having received the transmission information from the server 4, the management terminal 5 immediately displays an image corresponding to the image data included in the transmission information on the monitoring screen 31 (S15c). The image can be displayed on the monitoring screen 31 at a resolution corresponding to the communication amount instruction received in S52b.

According to the lapse of the predetermined cycle from S12c, the server 4 generates a synchronization signal and transmits the generated synchronization signal individually to the mobile object 2 and the management terminal 5 at the transfer rate determined in S1b (S13a).

Thereafter, processes similar to those in S23 to S24 in FIG. 15 may be repeated in the mobile object 2. Processes similar to S13a to S14a in FIG. 15 may be repeated in the server 4 while S15c is continued in the management terminal 5.

In this manner, in the management system 101, the task is predicted, the communication amount is determined according to the task type of the predicted task, and the data transmission is started from the vehicle in advance according to the communication amount, making it possible to immediately start the remote management (S10c) when the task is selected in the management terminal 5 and the task request is transmitted from the management terminal 5 to the server 4, enabling display of the image of the mobile object 2 on the monitoring screen of the management terminal 5. This makes it possible to achieve high efficiency in the remote management of the mobile object 2.

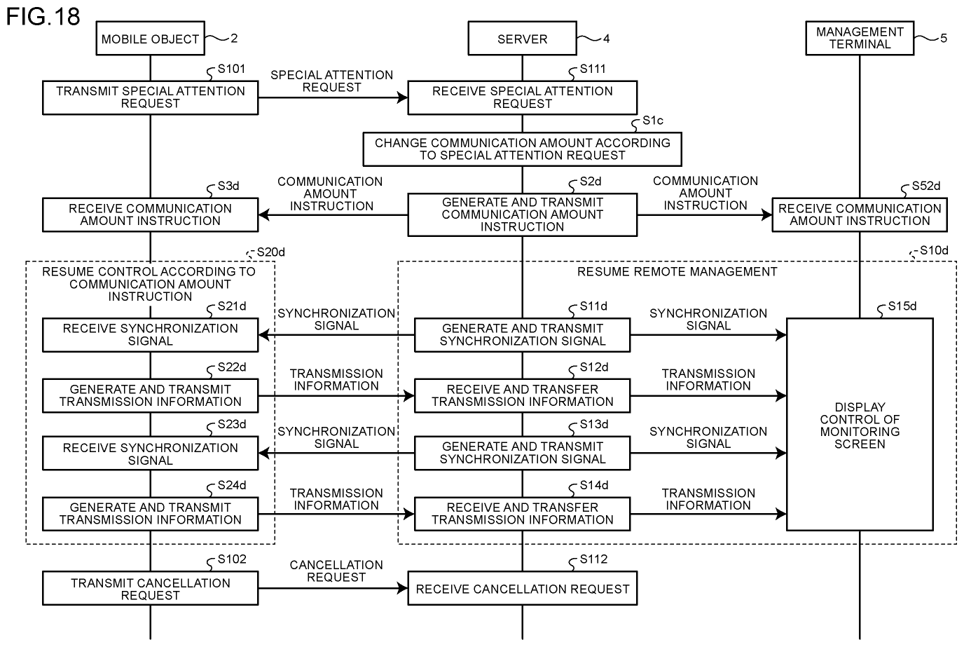

Alternatively, in the management method executed by the management system 101, as a second modification of the second embodiment, as illustrated in FIG. 18, the processes in S1c and subsequent steps may be started with a special attention request from the mobile object 2 as a trigger. FIG. 18 is a sequence diagram illustrating a management method according to the second modification of the second embodiment. While FIG. 18 illustrates processes between one mobile object 2, the server 4, and one management terminal 5, this similarly applies to processes between another mobile object 2, the server 4, and another management terminal 5.

In the management system 101, it is assumed that the mobile object 2 executes control (S20 in FIG. 15) corresponding to the communication amount instruction similarly to the second embodiment, and the server 4 and the management terminal 5 cooperatively execute remote management (S10a in FIG. 15) of the mobile object 2 similarly to the second embodiment.

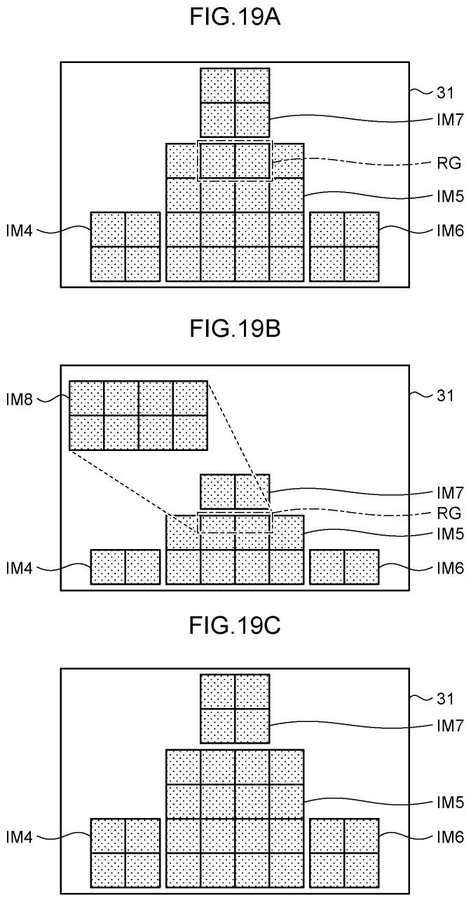

For example, in a case where the mobile object 2_1 has four sensors 21 and the task type of management of the mobile object 2 is “monitoring with image”, the management terminal 5 can display four images IM4 to IM7 as illustrated in FIG. 19A on the monitoring screen 31. FIG. 19A illustrates the monitoring screen 31 in which the sub images IM4 and IM6 are arranged on the left and right of the main image IM5, and the sub image IM7 is arranged above or below the main image IM5. The management terminal 5 may display the main image IM5 with a resolution of 4 pixels×4 pixels and display the sub images IM4, IM6, and IM7 with 2 pixels×2 pixels.

According to detecting the monitoring target being a target of attention around the mobile object 2, the mobile object 2 interrupts the control corresponding to the communication amount instruction (S20 in FIG. 15), generates a special attention request, and transmits the generated special attention request to the server 4 (S101). The special attention request includes a request for paying attention to a monitoring target being a target of attention in an enlarged display image. The monitoring target being a target of attention may include a signal, a sign, a traffic control flag, etc. existing around the mobile object 2. The monitoring target being a target of attention may include a moving object such as a person or a car present around mobile object 2. The enlargement magnification of the enlarged display image may be a magnification of enlarging within a range that causes no blind spot.

When having received the special attention request from the mobile object 2 via the communication link 6 (S111), the server 4 interrupts the remote management of the mobile object 2 (S10a in FIG. 15), and changes the communication amount between the management apparatus 3 and the mobile object 2 according to the special attention request (S1c). The server 4 determines the resolution of the enlarged display image of the monitoring target being a target of attention, and makes a change to decrease the resolution of the original image according to adding the enlarged display image having the determined resolution. This allows the server 4 to perform correction so that the increase in the total communication amount before and after the change falls within an allowable range. The server 4 generates a communication amount instruction including a request for adding the enlarged display image having the determined resolution and a request for changing the resolution of the original image, and transmits the generated communication amount instruction individually to the mobile object 2 and the management terminal 5 (S2d).

For example, when the mobile object 2_1 generates a special attention request to pay attention to the monitoring target corresponding to a region RG in the image IM5 illustrated in FIG. 19A and transmits the generated special attention request to the server 4, the server 4 may determine addition of the enlarged display image IM8 as illustrated in FIG. 19B as the enlarged display image of the region RG. The display size of the region RG may be 1 pixel×2 pixels. The server 4 may determine the display size of the enlarged display image IM8 to be 2 pixels×4 pixels, which is larger than the display size of the region RG. According to this, as illustrated in FIGS. 19A and 19B, the server 4 may lower the display size of the main image IM5 from 4 pixels×4pixels to 2 pixels×4 pixels, and lower the display sizes of the sub images IM4, IM6, and IM7 from 2 pixels×2 pixels to 1 pixel×2 pixels. With this operation, the total resolution before the change is 4 pixels×4 pixels+2 pixels ×2 pixels×3=28 pixels, and the total resolution after the change is 2 pixels×4 pixels+2 pixels×4 pixels+1 pixel×2 pixels ×3=22 pixels. The server 4 can suppress the increase in the resolution before and after the change to −pixels (22 pixels−28 pixels=−6 pixels), which can fall within the allowable range. The server 4 may generate a communication amount instruction including a request for adding the enlarged display image IM8 and a request for decreasing the resolution of the original images IM5 to IM7, and may transmit the generated communication amount instruction individually to the mobile object 2 and the management terminal 5.

When having received the communication amount instruction from the server 4 via the communication link 6 (S3d), the mobile object 2 resumes the control corresponding to the communication amount instruction (S20d). In S20d, the processes of S21d to S24d are performed. In parallel with this, the management terminal 5 receives the communication amount instruction from the server 4 via the communication link 7 (S52d). After S2a and S52d, the server 4 and the management terminal 5 cooperatively resume the remote management (S10d) of the mobile object 2. In S10d, the processing in S11d to S14d in the server 4 and the processing in S15d in the management terminal 5 are performed in parallel.

For example, when the remote management (S10d) of the mobile object 2 is resumed, the server 4 generates a synchronization signal and transmits the generated synchronization signal individually to the mobile object 2 and the management terminal 5 at the transfer rate changed in S1d (S11d). Together with this, the management terminal 5 resumes the display control of the monitoring screen 31 (S15d).

When having received the synchronization signal from the server 4 via the communication link 6 (S21d), the mobile object 2 captures an image of the surrounding environment by using the sensor 21, and acquires an image and an enlarged display image each having a resolution corresponding to the communication amount instruction. The mobile object 2 generates transmission information including image data corresponding to the acquired image and enlarged display image data corresponding to the enlarged display image, and transmits the generated transmission information to the server 4 (S22d). In parallel with this, the management terminal 5 receives the synchronization signal from the server 4 via the communication link 7.

When having received the transmission information from the mobile object 2 via the communication link 6, the server 4 transfers the received transmission information to the management terminal 5 via the communication link 7 (S12d). The management terminal 5 displays, on the monitoring screen 31, the image corresponding to the image data included in the transmission information and the enlarged display image corresponding to the enlarged display image data (S15d). At this time, each of the image and the enlarged display image can be individually displayed on the monitoring screen 31 at a resolution corresponding to the communication amount instruction received in S52d. The management terminal 5 may update and display the image and the enlarged display image on the monitoring screen 31 so as to be updated at a timing corresponding to the synchronization signal.

For example, the management terminal 5 can display four images IM4 to IM7 and an enlarged display image IM8 as illustrated in FIG. 19B on the monitoring screen 31. FIG. 19B illustrates the monitoring screen 31 in which the sub images IM4 and IM6 are arranged on the left and right of the main image IM5, the sub image IM7 is arranged above or below the main image IM5, a frame RG indicating the enlarged portion is arranged to be superimposed on the main image IM5, and the enlarged display image IM8 is displayed around the four images IM4 to IM7 in a mode associated with the frame RG. The management terminal 5 may display the main image IM5 with a resolution of 2 pixels×4 pixels, display the sub images IM4, IM6, and IM7 with a resolution of 1 pixel×2 pixels, and display the enlarged display image IM8 with a resolution of 2 pixels×4 pixels.

According to the lapse of a predetermined cycle from S11d, the server 4 generates a synchronization signal and transmits the generated synchronization signal individually to the mobile object 2 and the management terminal 5 at the transfer rate changed in S1d (S13d).

When having received the synchronization signal from the management apparatus 3 via the communication link 6 (S23d), the mobile object 2 captures an image of the surrounding environment by using the sensor 21, and acquires an image having resolution corresponding to the communication amount instruction and an enlarged display image. The mobile object 2 generates transmission information including image data corresponding to the acquired image and enlarged display image data corresponding to the enlarged display image, and transmits the generated transmission information to the server 4 (S24d). In parallel with this, the management terminal 5 receives the synchronization signal from the server 4 via the communication link 7.

When having received the transmission information from the mobile object 2 via the communication link 6, the server 4 transfers the received transmission information to the management terminal 5 via the communication link 7 (S14d). The management terminal 5 displays, on the monitoring screen 31, the image corresponding to the image data included in the transmission information and the enlarged display image corresponding to the enlarged display image data (S15a). At this time, each of the image and the enlarged display image can be individually displayed on the monitoring screen 31 at a resolution corresponding to the communication amount instruction received in S52d. The management terminal 5 may update and display the image and the enlarged display image on the monitoring screen 31 so as to be updated at a timing corresponding to the synchronization signal.

Although not illustrated, after S24d, the processes similar to S21d to S24d may be repeated in the mobile object 2. After S14d, processes similar to S11d to S14d may be repeated in the server 4 while S15d is continued in the management terminal 5.

According to detecting that the attention of the monitoring target becomes unnecessary, the mobile object 2 generates a cancellation request and transmits the generated cancellation request to the server 4 (S102). The cancellation request includes a request for canceling the monitoring corresponding to the special attention request.

When the server 4 receives the cancellation request from the mobile object 2 via the communication link 6 (S112), the processes of S1a, S2a, S3, and S52 illustrated in FIG. 15 are performed again according to the cancellation request, and the control corresponding to the communication amount instruction (S20 in FIG. 15) and the remote management of the mobile object 2 (S10a in FIG. 15) are performed again.

For example, the management terminal 5 can stop the display of the enlarged display image IM8 and can display the four images IM4 to IM7 at the original resolution on the monitoring screen 31 as illustrated in FIG. 19C. FIG. 19C illustrates the monitoring screen 31 in which the sub images IM4 and IM6 are arranged on the left and right of the main image IM5, and the sub image IM7 is arranged above or below the main image IM5. The management terminal 5 may display the main image IM5 with a resolution of 4 pixels×4 pixels and display the sub images IM4, IM6, and IM7 with 2 pixels×2 pixels.

In this manner, in the management system 101, the communication amount between the server 4 and the mobile object 2 is changed according to the special attention request from the mobile object 2, and a communication amount instruction including a request for performing communication with the changed communication amount is transmitted to the mobile object 2. This makes it possible to suppress the communication amount of information transmitted from the mobile object 2 to the server 4 via the communication link 6 to an appropriate communication amount corresponding to the special attention request. In addition, the server 4 can suppress the communication amount of information transmitted from the server 4 to the mobile object 2 via the communication link 6 to an appropriate communication amount corresponding to the special attention request.

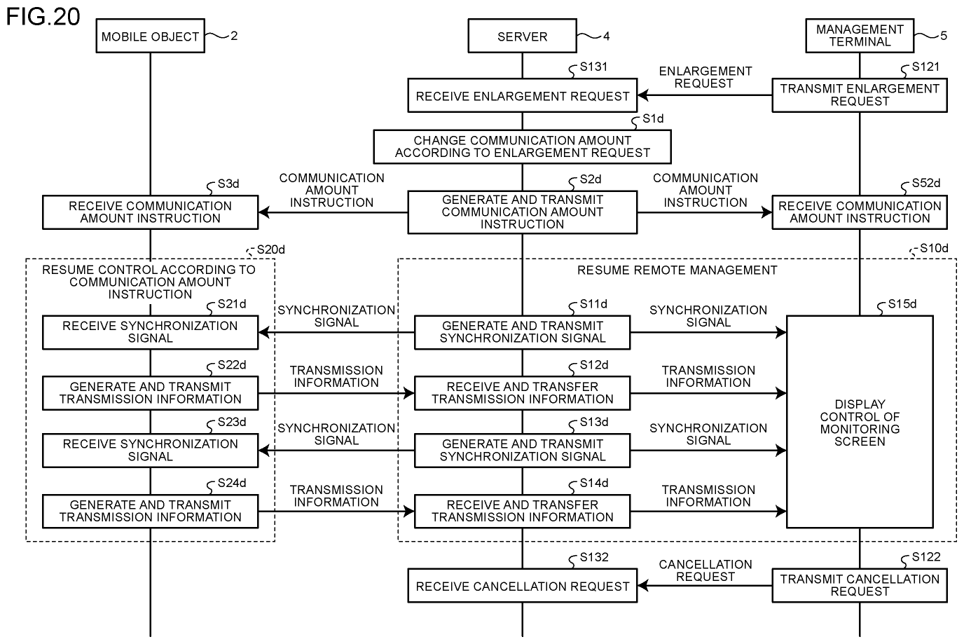

Alternatively, in the management method executed by the management system 101, as a third modification of the second embodiment, as illustrated in FIG. 20, the processes in S1d and subsequent steps may be started with an enlargement request from the management terminal 5 as a trigger. FIG. 20 is a sequence diagram illustrating the management method according to the second modification of the second embodiment. While FIG. 20 illustrates processes between one mobile object 2, the server 4, and one management terminal 5, this similarly applies to processes between another mobile object 2, the server 4, and another management terminal 5.

In the management system 101, it is assumed that the mobile object 2 executes control (S20 in FIG. 15) corresponding to the communication amount instruction similarly to the second embodiment, and the server 4 and the management terminal 5 cooperatively execute remote management (S10a in FIG. 15) of the mobile object 2 similarly to the second embodiment.

For example, in a case where the mobile object 2_1 has four sensors 21 and the task type of management of the mobile object 2 is “monitoring with image”, the management terminal 5 can display four images IM4 to IM7 as illustrated in FIG. 19A on the monitoring screen 31. FIG. 19A illustrates the monitoring screen 31 in which the sub images IM4 and IM6 are arranged on the left and right of the main image IM5, and the sub image IM7 is arranged above or below the main image IM5. The management terminal 5 may display the main image IM5 with a resolution of 4 pixels×4 pixels and display the sub images IM4, IM6, and IM7 with 2 pixels×2 pixels.

According to an enlargement instruction from the operator, the management terminal 5 generates an enlargement request and transmits the generated enlargement request to the server 4 (S121). The enlargement instruction includes an operation of an operator to instruct enlargement of a part of an image. The enlargement request includes a request for enlarging a part of the image displayed on the monitoring screen 31.

When having received the enlargement request from the management terminal 5 via the communication link 7 (S131), the server 4 interrupts the remote management of the mobile object 2 (S10a in FIG. 15), and changes the communication amount between the management apparatus 3 and the mobile object 2 according to the enlargement request (S1d). The server 4 determines the resolution of the enlarged display image, and makes a change to decrease the resolution of the original image according to adding the enlarged display image having the determined resolution. This allows the server 4 to perform correction so that the increase in the total communication amount before and after the change falls within an allowable range. The server 4 generates a communication amount instruction including a request for adding the enlarged display image having the determined resolution and a request for changing the resolution of the original image, and transmits the generated communication amount instruction individually to the mobile object 2 and the management terminal 5 (S2d).

For example, when the management terminal 5 generates an enlargement request corresponding to an enlargement instruction from the operator for the region RG in the image IM5 illustrated in FIG. 19A and transmits the generated enlargement request to the server 4, the server 4 may determine addition of the enlarged display image IM8 as illustrated in FIG. 19B as the enlarged display image of the region RG. When the monitoring screen 31 is a touch panel, the enlargement instruction may be performed as a touch operation on the region RG on the monitoring screen 31. The display size of the region RG may be 1 pixel×2 pixels. The server 4 may determine the display size of the enlarged display image IM8 to be 2 pixels×4 pixels, which is larger than the display size of the region RG. According to this, as illustrated in FIGS. 19A and 19B, the server 4 may lower the display size of the main image IM5 from 4 pixels×4 pixels to 2 pixels×4 pixels, and lower the display sizes of the sub images IM4, IM6, and IM7 from 2 pixels×2 pixels to 1 pixel×2 pixels. With this operation, the total resolution before the change is 4 pixels×4 pixels+2 pixels ×2 pixels×3=28 pixels, and the total resolution after the change is 2 pixels×4 pixels+2 pixels×4 pixels+1 pixel×2 pixels×3=22 pixels. The server 4 can suppress the increase in the resolution before and after the change to −6 pixels (22 pixels−28 pixels=−6 pixels), which can fall within the allowable range. The server 4 may generate a communication amount instruction including a request for adding the enlarged display image IM8 and a request for decreasing the resolution of the original images IM5 to IM7, and may transmit the generated communication amount instruction individually to the mobile object 2 and the management terminal 5.

When having received the communication amount instruction from the server 4 via the communication link 6 (S3d), the mobile object 2 resumes the control (S20d) corresponding to the communication amount instruction. In S20d, the processes of S21d to S24d are performed. In parallel with this, the management terminal 5 receives the communication amount instruction from the server 4 via the communication link 7 (S52d). After S2a and S52d, the server 4 and the management terminal 5 cooperatively resume the remote management (S10d) of the mobile object 2. In S10d, the processing in S11d to S14d in the server 4 and the processing in S15d in the management terminal 5 are performed in parallel.

For example, the management terminal 5 can display four images IM4 to IM7 and an enlarged display image IM8 as illustrated in FIG. 19B on the monitoring screen 31. FIG. 19B illustrates the monitoring screen 31 in which the sub images IM4 and IM6 are arranged on the left and right of the main image IM5, the sub image IM7 is arranged above or below the main image IM5, a frame RG indicating the enlarged portion is arranged to be superimposed on the main image IM5, and the enlarged display image IM8 is displayed around the four images IM4 to IM7 in a mode associated with the frame RG. The management terminal 5 may display the main image IM5 with a resolution of 2 pixels×4 pixels, display the sub images IM4, IM6, and IM7 with a resolution of 1 pixel×2 pixels, and display the enlarged display image IM8 with a resolution of 2 pixels×4 pixels.

According to a cancellation instruction from the operator, the management terminal 5 generates a cancellation request and transmits the generated cancellation request to the server 4 (S122). The cancellation instruction includes an operation of an operator instructing to cancel enlargement of a part of an image. The cancellation request includes a request for cancelling the enlarged display of a part of the image on the monitoring screen 31.

When the server 4 receives the cancellation request from the management terminal 5 via the communication link 6 (S132), the processes of S1a, S2a, S3, and S52 illustrated in FIG. 15 are performed again according to the cancellation request, and the control corresponding to the communication amount instruction (S20 in FIG. 15) and the remote management of the mobile object 2 (S10a in FIG. 15) are performed again.

For example, when the management terminal 5 generates a cancellation request corresponding to a cancellation instruction for the enlarged display image from the operator and transmits the generated cancellation request to the server 4, the server 4 may determine cancellation of the enlarged display image IM8 as illustrated in FIG. 19B. When the monitoring screen 31 is a touch panel, the cancellation instruction may be performed as a touch operation on the enlarged display image IM8 on the monitoring screen 31. According to this, the management terminal 5 can stop the display of the enlarged display image IM8 and can display the four images IM4 to IM7 at the original resolution on the monitoring screen 31 as illustrated in FIG. 19C. FIG. 19C illustrates the monitoring screen 31 in which the sub images IM4 and IM6 are arranged on the left and right of the main image IM5, and the sub image IM7 is arranged above or below the main image IM5. The management terminal 5 may display the main image IM5 with a resolution of 4 pixels×4 pixels and display the sub images IM4, IM6, and IM7 with 2 pixels×2 pixels.

In this manner, in the management system 101, the communication amount between the server 4 and the mobile object 2 is changed according to the enlargement request from the management terminal 5, and a communication amount instruction including a request for performing communication with the changed communication amount is transmitted to the mobile object 2. This makes it possible to suppress the communication amount of information transmitted from the mobile object 2 to the server 4 via the communication link 6 to an appropriate communication amount corresponding to the enlargement request. In addition, the server 4 can suppress the communication amount of information transmitted from the server 4 to the mobile object 2 via the communication link 6 to an appropriate communication amount corresponding to the enlargement request.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A management method comprising:
determining a communication amount between a management apparatus and a mobile object according to a task type of remote management of the mobile object, the management apparatus being capable of communicating with the mobile object; and
transmitting, to the mobile object, a communication amount instruction including a request for performing communication with the determined communication amount.

2. The management method according to claim 1, wherein
the determining the communication amount includes determining a communication amount of information transmitted from the mobile object to the management apparatus according to a task type of management of the mobile object.

3. The management method according to claim 1, wherein
the determining the communication amount includes determining a communication amount of information transmitted from the management apparatus to the mobile object according to a task type of management of the mobile object.

4. The management method according to claim 2, wherein
the determining the communication amount includes
determining a resolution of image data transmitted from the mobile object to the management apparatus according to a task type of management of the mobile object.

5. The management method according to claim 2, wherein
the determining the communication amount includes:
determining a quantity of the mobile objects to be monitoring targets in the management apparatus according to the task type of management of the mobile object; and
determining a resolution of image data to be transmitted from the mobile object to the management apparatus according to the determined quantity of the monitoring targets.

6. The management method according to claim 2, wherein
the determining the communication amount includes:
determining a layout of a monitoring screen of the management apparatus according to the task type of management of the mobile object; and
determining a resolution of image data to be transmitted from the mobile object to the management apparatus according to the determined layout of the monitoring screen.

7. The management method according to claim 3, wherein
the determining the communication amount includes determining a transfer rate of a synchronization signal transmitted from the management apparatus to the mobile object according to the task type of management of the mobile object.

8. The management method according to claim 1, wherein
the task type includes at least one of monitoring with image, monitoring without image, attention, and manipulation.

9. A mobile object comprising:
a sensor;
a communication interface connectable to a management apparatus; and
a controller capable of controlling the sensor and the communication interface, wherein
in response to the communication interface receiving a communication amount instruction including a request for performing communication with a communication amount determined according to a task type of remote management, the controller is configured to perform control to communicate with the management apparatus with a communication amount corresponding to the communication amount instruction.

10. The mobile object according to claim 9, wherein
the controller is configured to process an acquired image such that a data size of the acquired image becomes a data size according to the communication amount instruction.

11. The mobile object according to claim 9, wherein
the controller is configured to perform control such that a data size of image data generated from an image acquired by the sensor becomes a data size according to the communication amount instruction.

12. An information processing apparatus mounted on a mobile object, the information processing apparatus comprising:
a communication interface connectable to a management apparatus; and
a controller capable of controlling a sensor and the communication interface, wherein
in response to the communication interface receiving a communication amount instruction including a request for performing communication with a communication amount determined according to a task type of remote management, the controller is configured to perform control to communicate with the management apparatus with a communication amount corresponding to the communication amount instruction.

13. The information processing apparatus according to claim 12, wherein
the controller is configured to process an acquired image such that a data size of the acquired image becomes a data size according to the communication amount instruction.

14. The information processing apparatus according to claim 12, wherein
the controller is configured to perform control such that a data size of image data generated from an image acquired by the sensor becomes a data size according to the communication amount instruction.
